(19) United States
(12) Patent Application Publication
(10) Pub. No.: US 2019/0045706 A1
(43) Pub. Date: Feb. 14, 2019

(54) Systems, Devices and Components for Automated Planting and Supporting Automated Planters and Methods of Using Same

(71) Applicant: SUPERPLANTER T.K. LTD., Ram-On (IL)

(72) Inventor: Nisan Kafri, Ram-On (IL)

(21) Appl. No.: 15/675,744

(22) Filed: Aug. 13, 2017

(51) Int. Cl. A01C 11/02

(52) U.S. Cl. CPC A01C 11/025

(57) ABSTRACT

According to some embodiments of the present invention, an automated planter may be comprised of a series/sequence of automated sub-systems. The sequence of sub-systems may be designed to receive trays/cartridges of seedlings, withdraw the seedlings from the trays and plant the seedlings one by one as the automated planter advances, all in an automated fashion

### FIELD OF THE INVENTION

The present invention generally relates to the field of Automated Planting. More specifically, the present invention relates to systems, devices and components for automated planting and supporting automated planters and methods of using same.

### BACKGROUND

In modern agriculture, seeds are no longer planted in the field they are intended to populate. The seeds are planted, sprouted and grown to seedlings offsite, or cloned offsite, and planted in the field as seedlings. These seedlings are commonly packaged in trays comprised of a grid of cells (an illustration of such a tray is shown in FIG. 8 and marked w), each cell being designed to hold a clump of dirt surrounding and nourishing the roots of a single seedling (an illustration of such a seedling with dirt is shown in FIG. 7). The seedlings must then each be planted in the ground in the location they are intended to grow.

Thus, modern automated planting machines are faced with the challenge of transferring each seedling from the tray into the ground, without damaging the seedling or shaking the dirt from its roots. Although many such systems exist, their mechanisms tend to be callous and damaging to the seedlings, thereby leading to a rougher acclimation for the seedlings in the field and as a consequence, inferior crops. Present planting machines also tend to encounter frequent “misses” such that they must be followed by manual labor to repair the “misses”.

The final stage of the automated planting process is the insertion of the seedling into the ground. This can be accomplished in many ways. An example of an automated system for inserting seedlings into the ground can be found in U.S. Pat. No. 4,765,260, titled “Machine for Planting Seedlings”, filed by one of the inventors of the present Application on May 22, 1987, which is hereby incorporated by reference in its entirety into the present Application.

As can be seen in this exemplary system, and in other automated systems for inserting seedlings into the ground, the seedlings must be fed into the insertion system one by one, using precise timing. Therefore, there is a need to first withdraw the seedlings from the trays they arrive in, transfer them to a mechanism for feeding them to the insertion system and then feed them to the insertion system one by one. It is during these transfers and feeding of the seedlings (i.e. when the seedling is outside the tray) that much of the damage to the seedlings occurs. It is also these transfer and feeding mechanisms that are difficult to time and prone to malfunction, thus limiting the speed automated planting can be performed and causing most of the above mentioned “misses”.

As such, the need for improved machines and methods for transferring seedlings from seedling trays to automated planters and feeding them thereto is clear.

### SUMMARY OF THE INVENTION

The present invention includes systems, devices and components for automated planting and supporting automated planters and methods of using same.

As shown in the exemplary illustration in FIG. 1, according to some embodiments of the present invention, a system for automated planting may include:
1. an automated planter (150);
2. one or more ancillary subsystems/devices (130) (e.g. pneumatic systems, an electric generator/transformer);
3. one or more carriages/supports (120) for the ancillary subsystems/devices;
4. means for propelling/driving the system (e.g. a tractor (110)).

As can be seen in the illustration, in this exemplary embodiment, the tractor (110) pulls the automated planter (150) forward while pushing a carriage (120) carrying electrical and pneumatic ancillary systems (130) before it. A wheel (201) attached to the automated planter serves to time the operation of the planter to the speed of forward motion.

As shown in the exemplary illustrations in FIGS. 2A-2F, according to some embodiments of the present invention, an automated planter may be comprised of a series/sequence of automated sub-systems. The sequence of sub-systems may be designed to receive trays/cartridges of seedlings, withdraw the seedlings from the trays and plant the seedlings one by one as the automated planter advances in an automated fashion.

For this purpose, the series/sequence of automated sub-systems may further include subsystems designed to transfer the seedlings to transitory trays/cartridges/mediums having different dimensions, different divisions/separations and/or different openings, designed to facilitate the operation of the other subsystems within the series/sequence of automated sub-systems.

An example of an automated planter comprised of such a series/sequence of automated subsystems is shown from different angles in FIGS. 2A-2E. FIG. 2F shows an exploded view, showing each of the subsystems separately.

The first subsystem (210 the “top” subsystem), receives seedling trays, withdraws the seedlings from the seedling trays using automated seedling grippers (xx), automatically modifies the spacing between the seedlings by modifying the spacing between the grippers and then transfers the seedlings to first transitory trays (xx), in the new spacing, to be received by the second subsystem (220—the “middle” subsystem).

The second subsystem (220—the “middle” subsystem) may receive the first transitory trays, transfer the seedlings from the first transitory trays, row by row (or in sets of rows—e.g. 3 rows at a time), into second transitory containers, from which the seedlings may be transferred to a conveyer belt of seedling containers (shown in FIG. 11A). The second subsystem may further include a seedling dispenser (shown in FIGS. 10A-10E) designed to timely dispense seedlings from the conveyer belt of seedling containers into chutes reaching a third subsystem (230—the “bottom” system) designed to plant the seedlings.

An example of the third subsystem (230—the “bottom” system) designed to plant the seedlings can be found in U.S. Pat. No. 4,765,260, titled “Machine for Planting Seedlings”, filed by one of the inventors of the present Application on May 22, 1987, which is hereby incorporated by reference in its entirety into the present Application.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary system for automated planting, according to some embodiments of the present invention;

FIGS. 2A-2F present illustrations of an example of an automated planter comprised of a series/sequence of automated subsystems from different angles, wherein:

FIG. 2A shows a perspective view;

FIG. 2B shows a side view;

FIG. 2C shows another perspective view;

FIG. 2D shows another side view;

FIG. 2E shows a rear view;

FIG. 2F shows an exploded view, showing each of the subsystems separately;

all according to some embodiments of the present invention;

FIG. 3 shows an illustration of an exemplary subsystem for receiving seedling trays, withdrawing the seedlings from the seedling trays using automated seedling grippers, automatically modifying the spacing between the seedlings by modifying the spacing between the grippers and then transferring the seedlings to transitory trays, in the new spacing, to be received by the another subsystem;

FIGS. 4A-4I present illustrations of an example of an alignment module, its components and its operation, all according to some embodiments of the present invention, wherein:

FIG. 4A shows a schematic alignment module prior to insertion into a schematic seedling tray;

FIG. 4B shows a close up illustration of components of the exemplary alignment module;

FIG. 4C shows illustrations of an exemplary alignment rod from different angles;

FIG. 4D shows an exemplary alignment rod being inserted between seedlings;

FIG. 4E shows two illustrations of an exemplary alignment module being inserted between seedlings, the top illustration being from a front angle and the bottom illustration being from a side angle;

FIGS. 4F &4G show an exemplary alignment module during stages of insertion between seedlings in position between seedlings after insertion, wherein FIG. 4F shows a first stage and FIG. 4G shows a second stage;

FIGS. 4H &4I show blueprints of an exemplary alignment module in operation, before (4H) and after (4I) insertion into a seedling tray;

all according to some embodiments of the present invention;

FIGS. 5A-5E present illustrations of an example of a dividing module, its components and its operation, all according to some embodiments of the present invention, wherein:

FIG. 5A shows a schematic of an exemplary dividing module;

FIG. 5B shows a schematic of an exemplary dividing module followed by a gripper field prior to insertion between seedlings in a seedling tray;

FIG. 5C shows blueprints of an exemplary dividing module in operation, before insertion into a seedling tray;

FIG. 5D shows an exemplary dividing module being inserted between seedlings;

FIG. 5E shows an exemplary dividing module being inserted between seedlings from a front angle;

FIG. 5F shows the exemplary dividing module after passing through the exemplary seedlings, having preceded an exemplary field of grippers now in position to grip the seedlings;

FIG. 5G shows the exemplary dividing module in front of the field of grippers now in position to grip the seedlings and the alignment module, now withdrawn from between the seedlings;

all according to some embodiments of the present invention;

FIGS. 6A-6R present illustrations of an example of a gripper field, its components and its operation, all according to some embodiments of the present invention, wherein:

FIG. 6A shows a schematic illustration of an array of grippers supported by an array of exemplary gripper supports;

FIG. 6B shows close up illustrations of an exemplary gripper;

FIG. 6C shows blueprints of an exemplary gripper array/field, from above and in 2 different cross sections;

FIGS. 6D-6E show exemplary grippers gripping seedlings in a tray by their stem, from different angles, wherein FIG. 6D shows a perspective angle and FIG. 6E shows front and side angles;

FIGS. 6F-6G show the seedlings gripped by their stems lifted from the seedling tray, wherein FIG. 6F shows the seedlings as they are being lifted from the tray and FIG. 6G shows a close up of the seedlings being held by the grippers, without the tray;

FIG. 6H shows the seedlings gripped by their stems being respaced by the movement of the exemplary gripper supports;

FIG. 6I shows blueprints of an exemplary gripper array/field, from above, after seedlings have been released and before the grippers have been retracted to the smaller spacing;

FIG. 6J shows blueprints of an exemplary gripper array/field, from above, after the grippers have been retracted to the smaller spacing;

FIG. 6K shows blueprints of an exemplary gripper array/field, from below, after seedlings have been released and before the grippers have been retracted to the smaller spacing;

FIG. 6L shows blueprints of an exemplary gripper array/field, from below, after the grippers have been retracted to the smaller spacing;

FIGS. 6M-6P show an exemplary series of schematic illustrations of the seedlings being inserted into a transitory tray, wherein:

FIG. 6M shows a first stage of the seedlings being inserted into a transitory tray;

FIG. 6N shows a second stage of the seedlings being inserted into a transitory tray;

FIG. 6O shows a third stage of the seedlings being inserted into a transitory tray;

FIG. 6P shows a fourth stage of the seedlings being inserted into a transitory tray;

FIG. 6Q shows the exemplary grippers being lifted from the transitory trays after depositing the seedlings;

FIG. 6R shows the exemplary grippers returned to their original spacing, ready to begin again;

all according to some embodiments of the present invention;

FIG. 7 shows a schematic illustration of an exemplary seedling, according to some embodiments of the present invention;

FIG. 8 shows a schematic illustration of an exemplary seedling tray, according to some embodiments of the present invention;

FIG. 9 shows a schematic illustration of an exemplary transitory seedling tray, according to some embodiments of the present invention;

FIGS. 10A-10E present illustrations of an example of a seedling dispenser, its components and its operation, all according to some embodiments of the present invention, wherein:

FIG. 10A shows an exemplary seedling dispenser from different angles;

FIG. 10B shows an exploded view of the exemplary seedling dispenser;

FIG. 10C shows an exemplary seedling dispenser attached to a chute for seedling dispense;

FIG. 10D shows an exemplary seedling dispenser attached to a set of chutes for seedling dispense;

FIG. 10E shows a pair of exemplary seedling dispensers attached to an exemplary planting subsystem;

all according to some embodiments of the present invention;

FIGS. 11A-11B present illustrations of an example of a conveyer belt of seedling containers, its components and its operation, all according to some embodiments of the present invention, wherein:

FIG. 11A shows a schematic of an exemplary conveyer belt of seedling containers;

FIG. 11B shows a schematic of an exemplary conveyer belt of seedling containers with focus on an exemplary sensing subsystem associated with the conveyer belt;

all according to some embodiments of the present invention;

FIG. 12 shows a schematic illustration of an exemplary second transitory tray of a middle subsystem, according to some embodiments of the present invention;

FIG. 13 shows a schematic illustration of an exemplary second transitory tray of a middle subsystem, attached to a set of channels leading to an exemplary conveyer belt of seedling containers, according to some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The present invention includes machines, systems and components for automated planting of seedlings and methods of use of same.

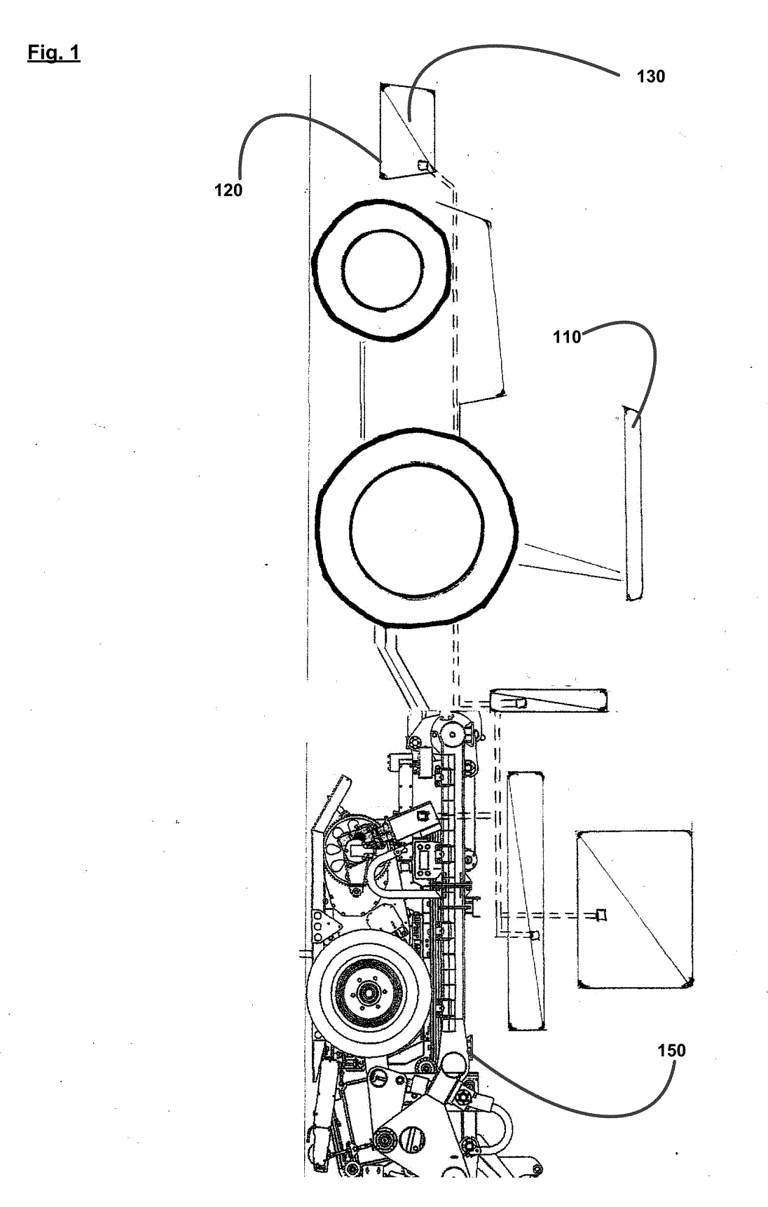

As shown in the exemplary illustration in FIG. 1, according to some embodiments of the present invention, a system for automated planting may include:
a. an automated planter (150);
b. one or more ancillary subsystems/devices (130) (e.g. air pressure systems, an electric generator/transformer);
c. one or more carriages/supports (120) for the ancillary subsystems/devices;
d. means for propelling/driving the system (e.g. a tractor (110)).

As can be seen in the illustration, in this exemplary embodiment, the tractor (110) pulls the automated planter (150) forward while carrying or pushing a carriage (120) carrying electrical and pneumatic ancillary systems (130) before it. A wheel (201) attached to the automated planter serves to time the operation of the planter to the speed of forward motion.

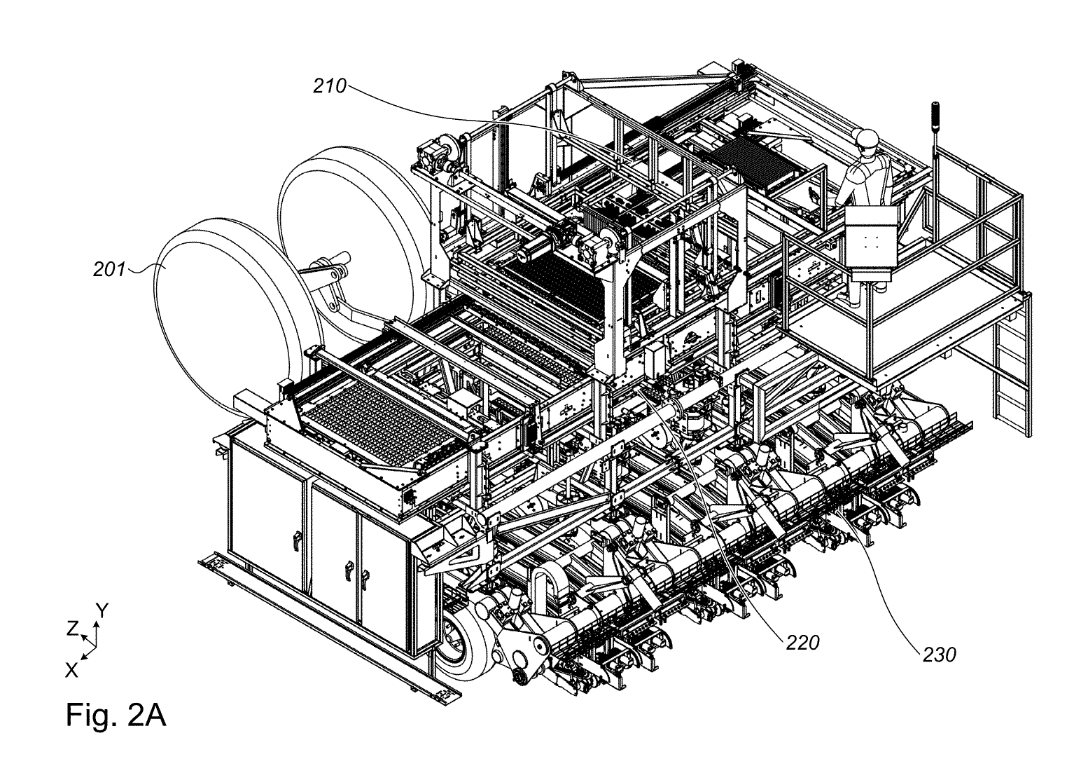

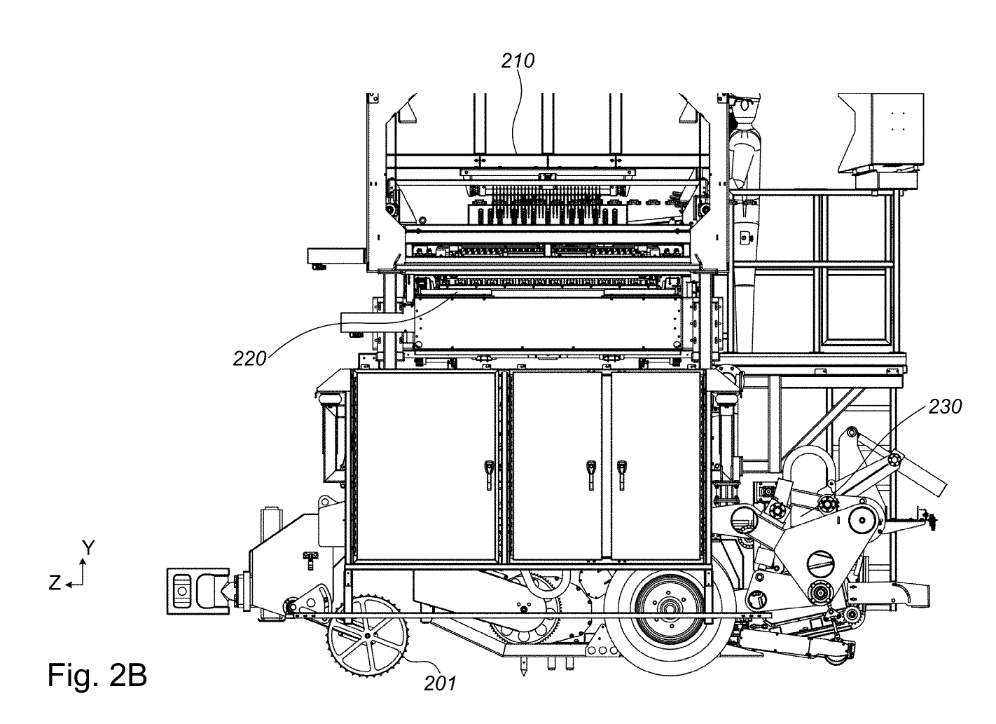

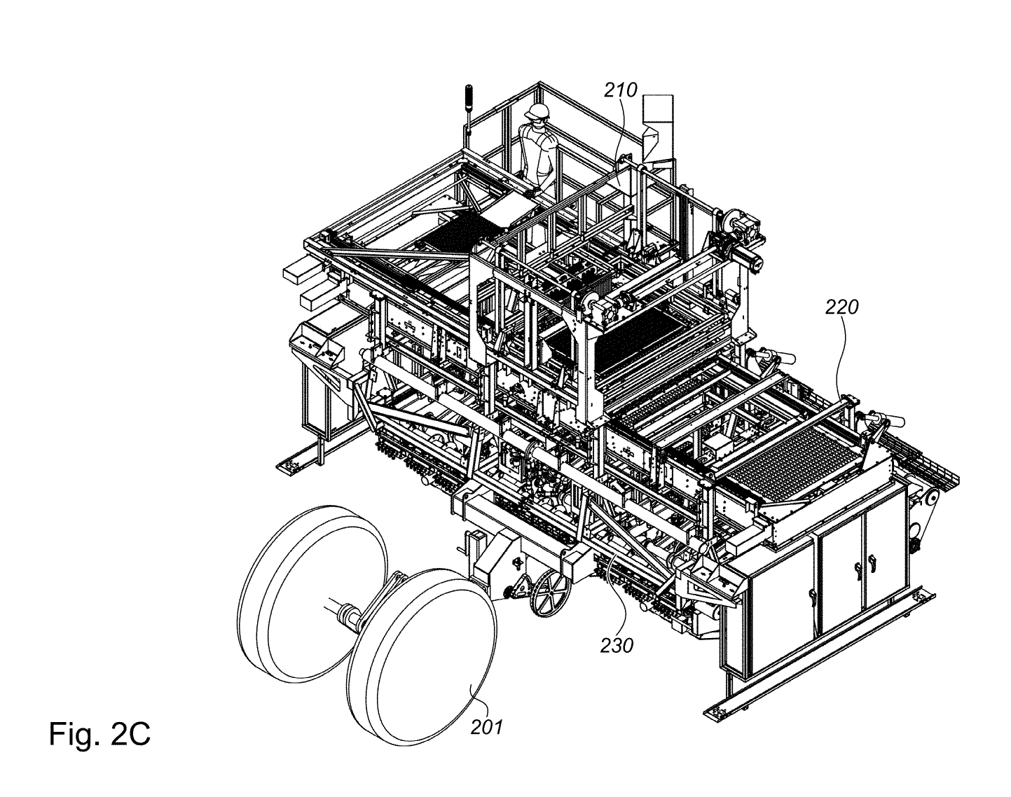

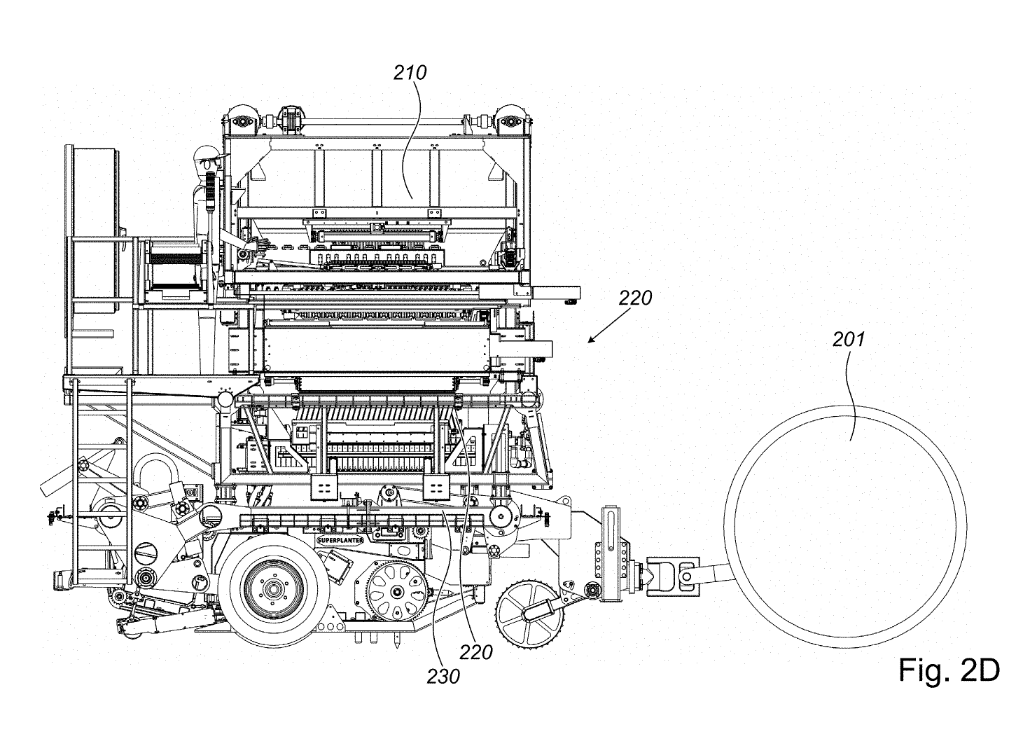

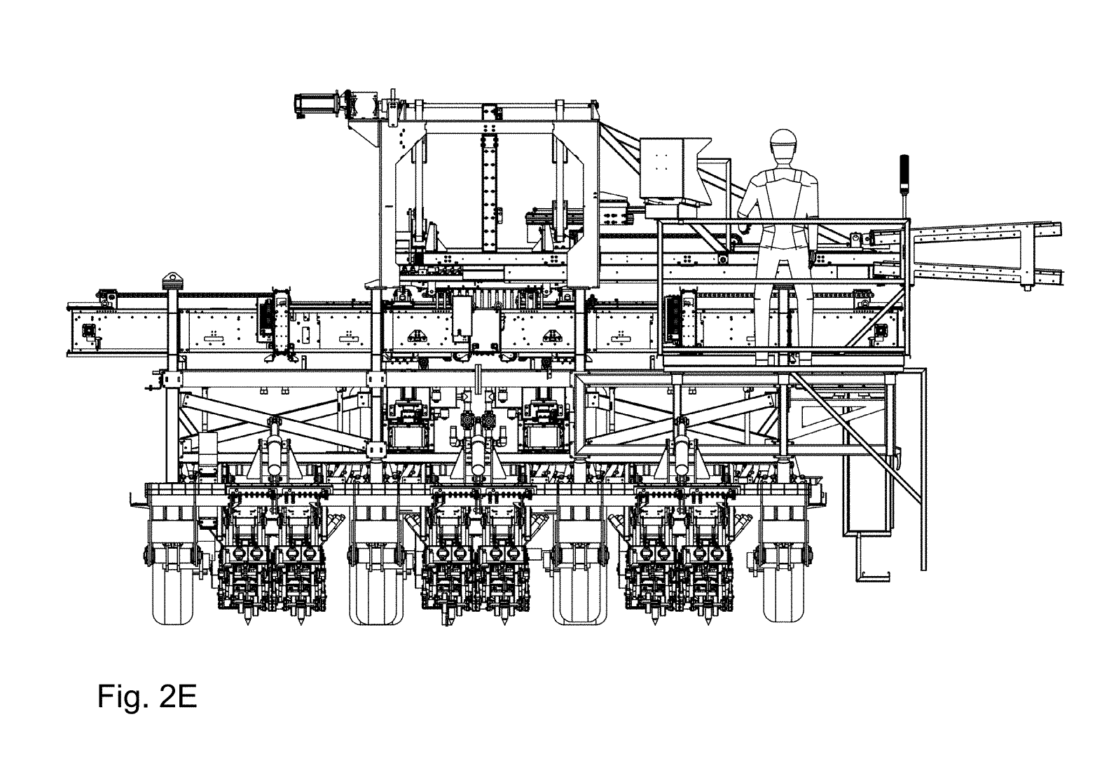

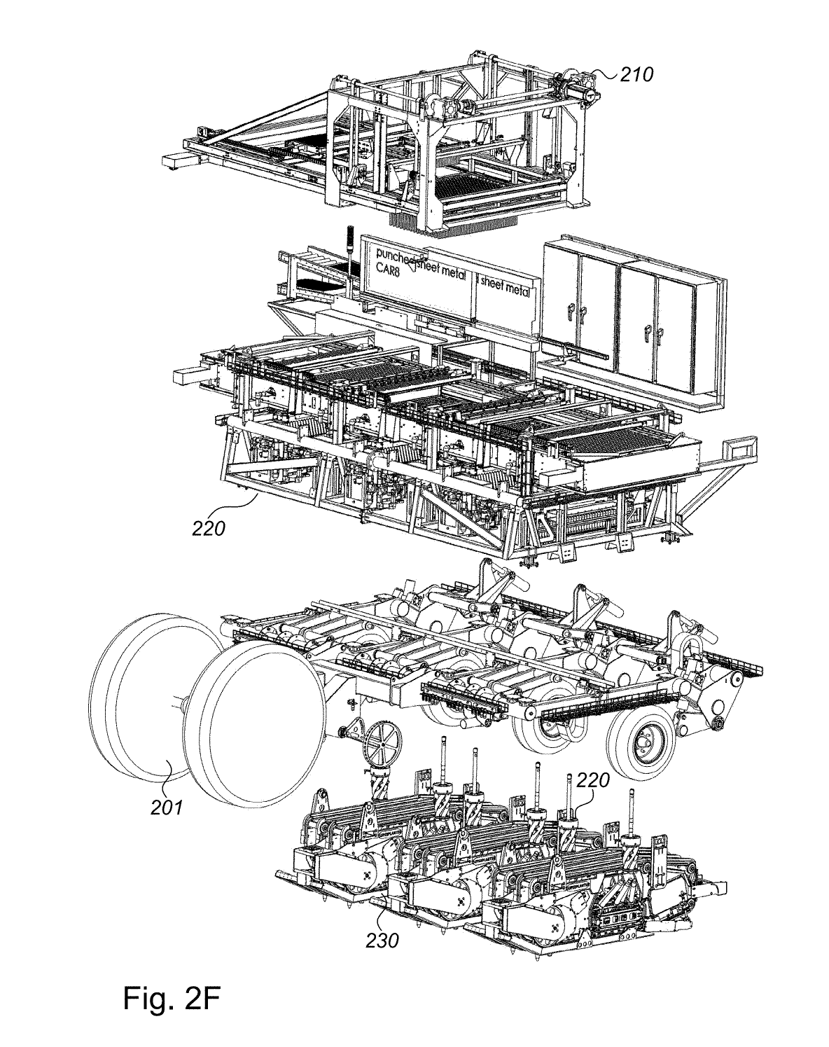

As shown in the exemplary illustrations in FIGS. 2A-2F, according to some embodiments of the present invention, an automated planter may be comprised of a series/sequence of automated sub-systems. The sequence of sub-systems may be designed to receive trays/cartridges of seedlings, withdraw the seedlings from the trays and plant the seedlings one by one as the automated planter advances in an automated fashion.

For this purpose, the series/sequence of automated sub-systems may further include subsystems designed to transfer the seedlings to transitory trays/cartridges/mediums having different dimensions, different divisions/separations and/or different openings, designed to facilitate the operation of the other subsystems within the series/sequence of automated sub-systems.

An example of an automated planter comprised of such a series/sequence of automated subsystems is shown from different angles in FIGS. 2A-2E. FIG. 2F shows an exploded view, showing each of the subsystems separately.

### The “Top” Subsystem

### Seedling Withdrawal, Respacing and Deposit-in/Transfer-to Transitory Trays

The exemplary first subsystem (210 the “top” subsystem), receives seedling trays, withdraws the seedlings from the seedling trays using automated seedling grippers (610), automatically modifies the spacing between the seedlings, by modifying the spacing between the grippers, and then transfers the seedlings to first transitory trays (381), in the new spacing, to be received by the second subsystem (220—the “middle” subsystem).

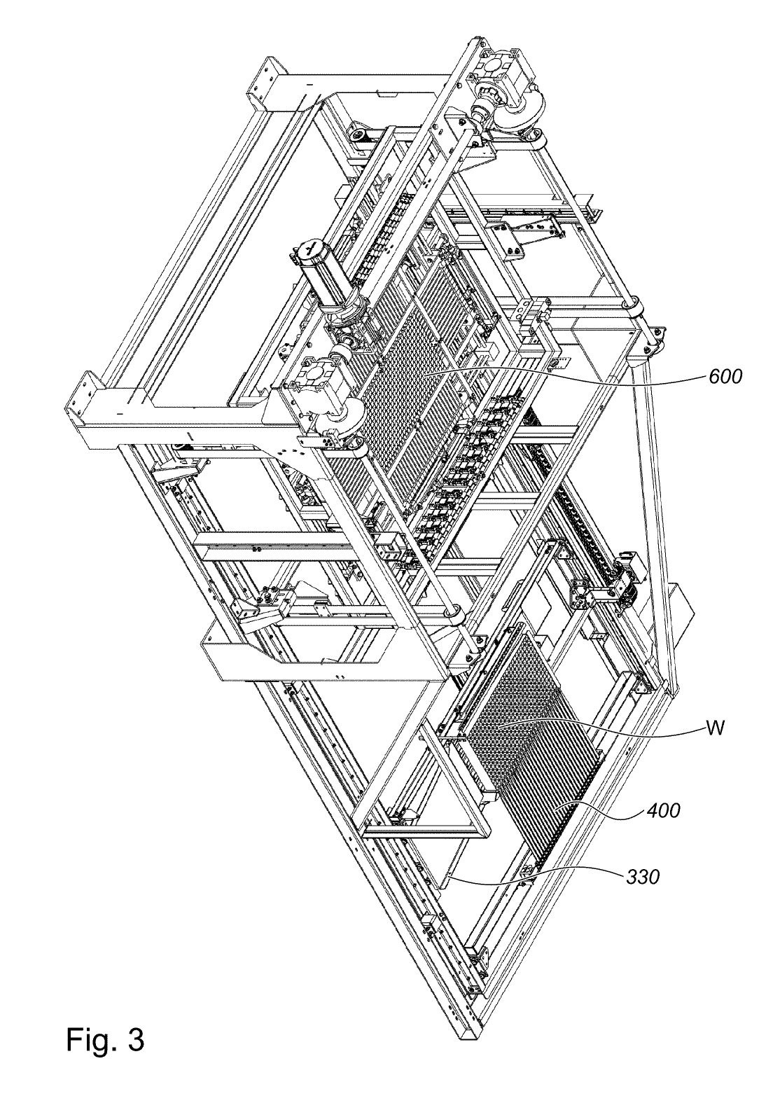

FIG. 3 shows an illustration of an exemplary subsystem for receiving seedling trays, withdrawing the seedlings from the seedling trays using automated seedling grippers, automatically modifying the spacing between the seedlings by modifying the spacing between the grippers and then transferring the seedlings to transitory trays, in the new spacing, to be received by the another subsystem.

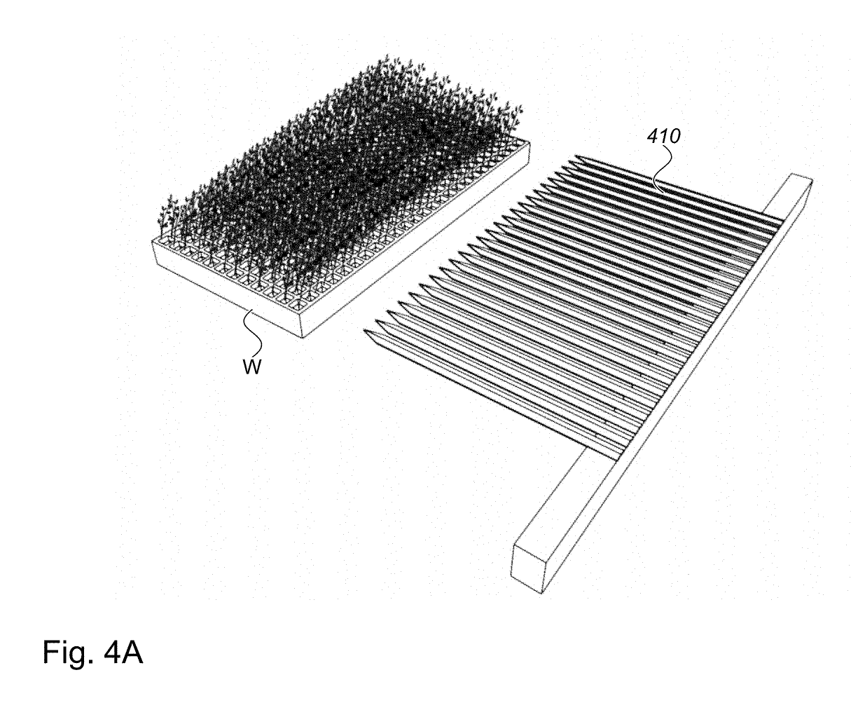

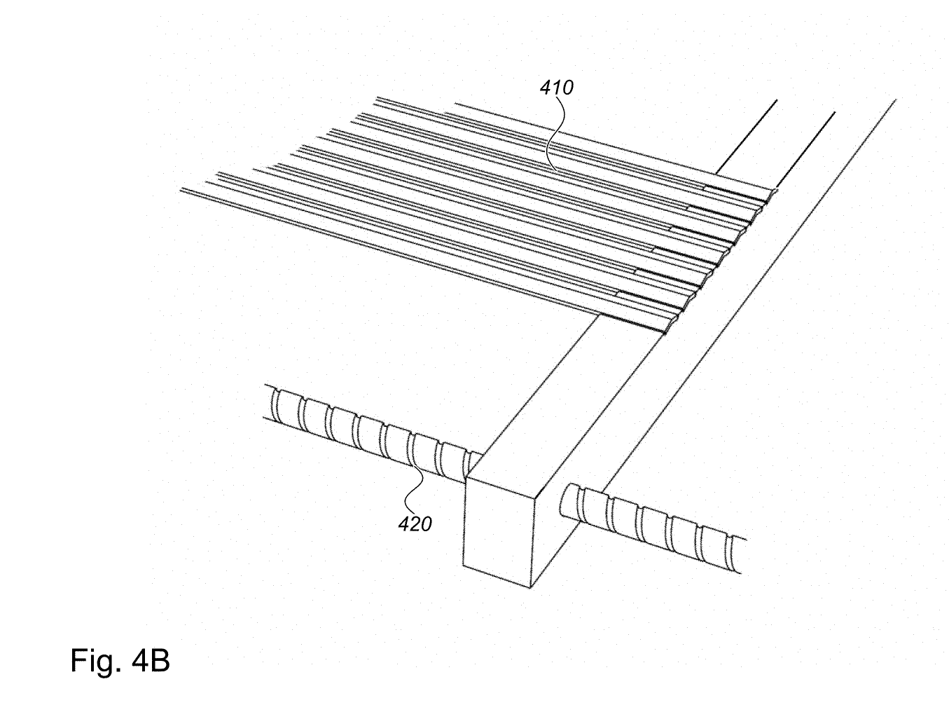

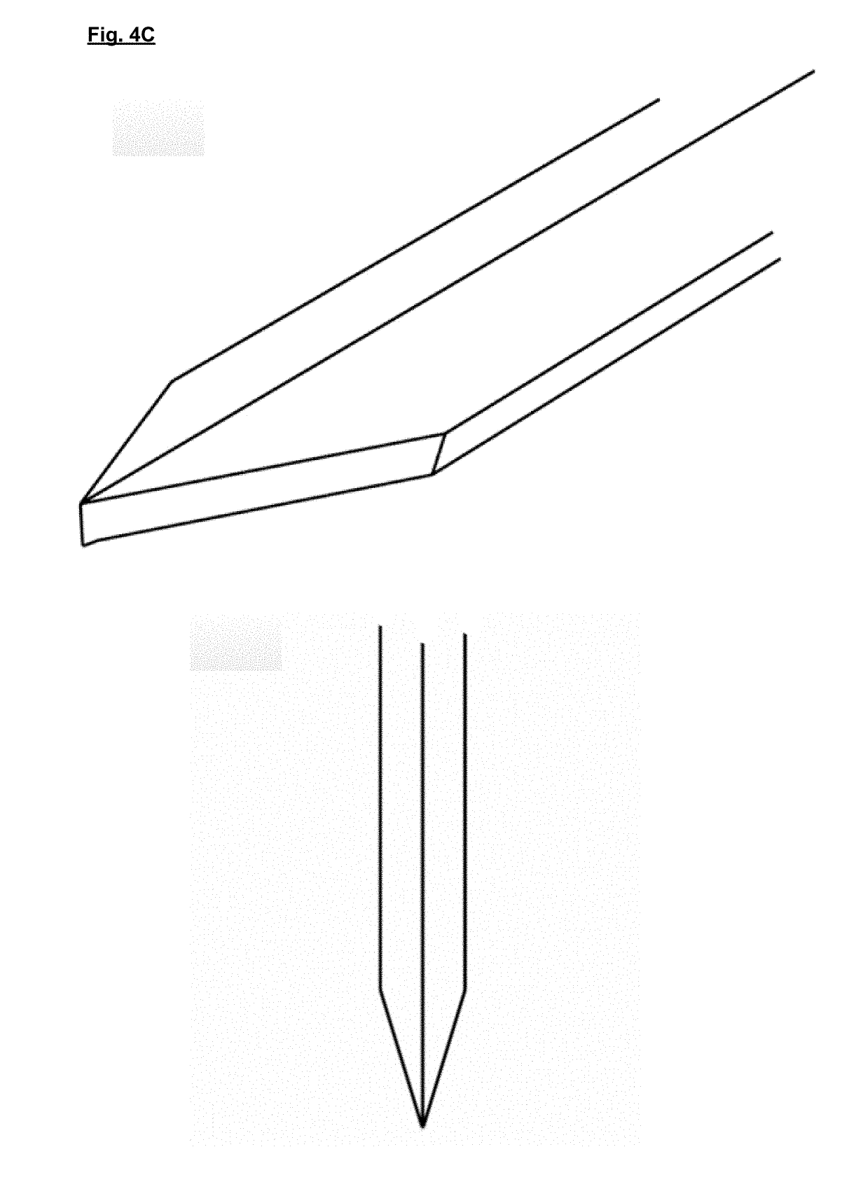

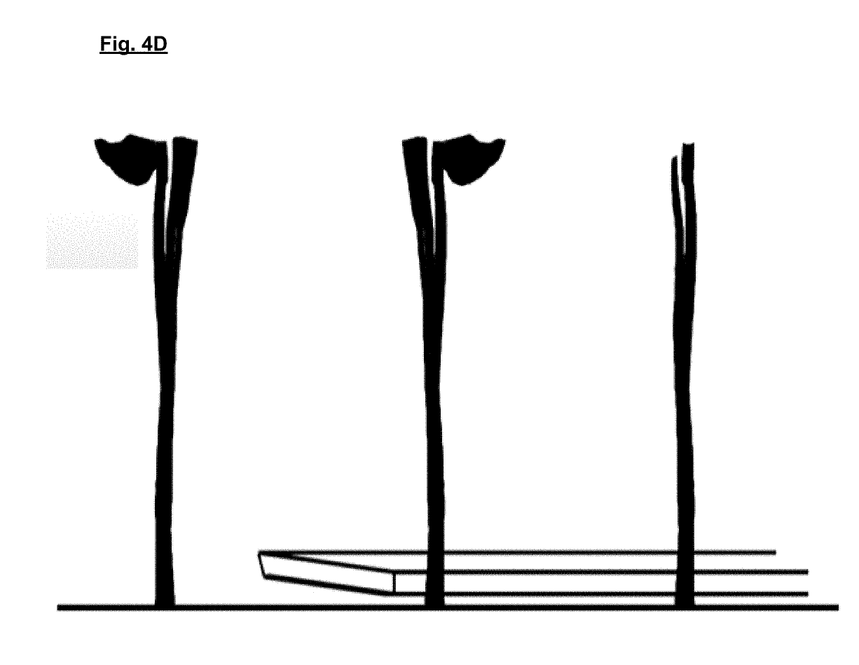

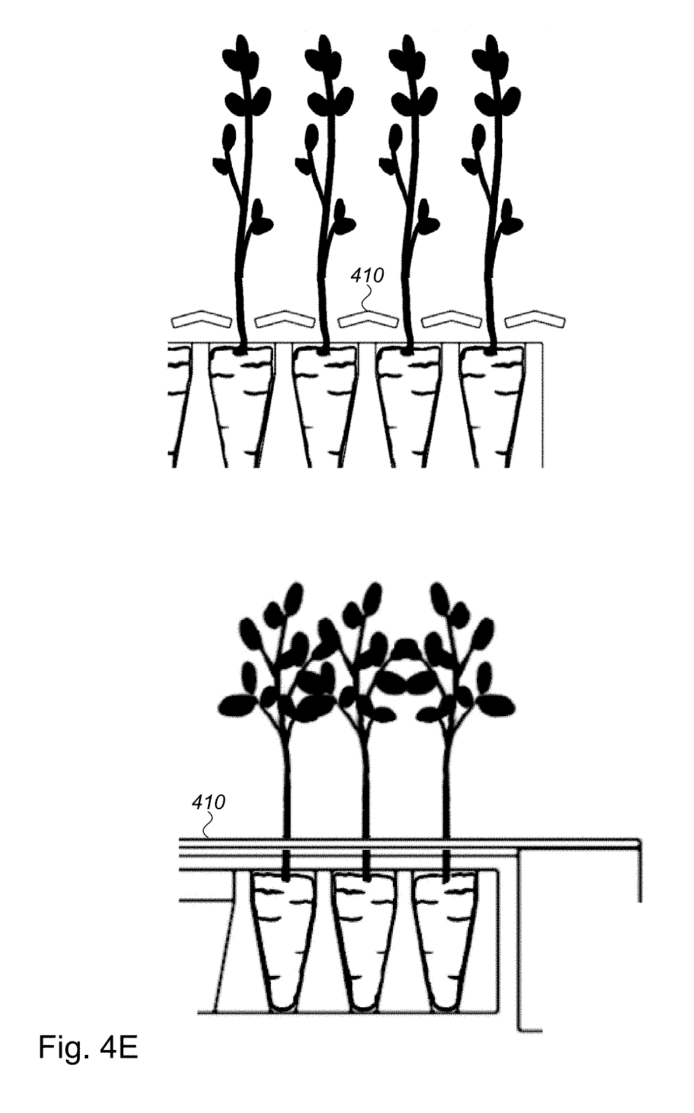

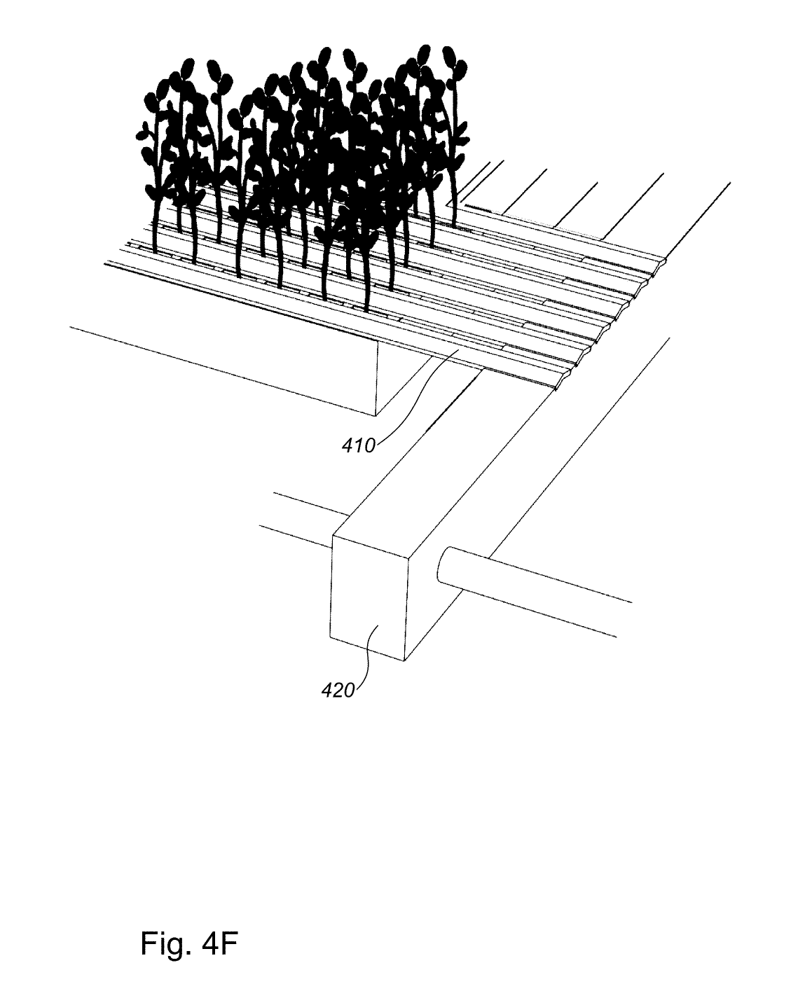

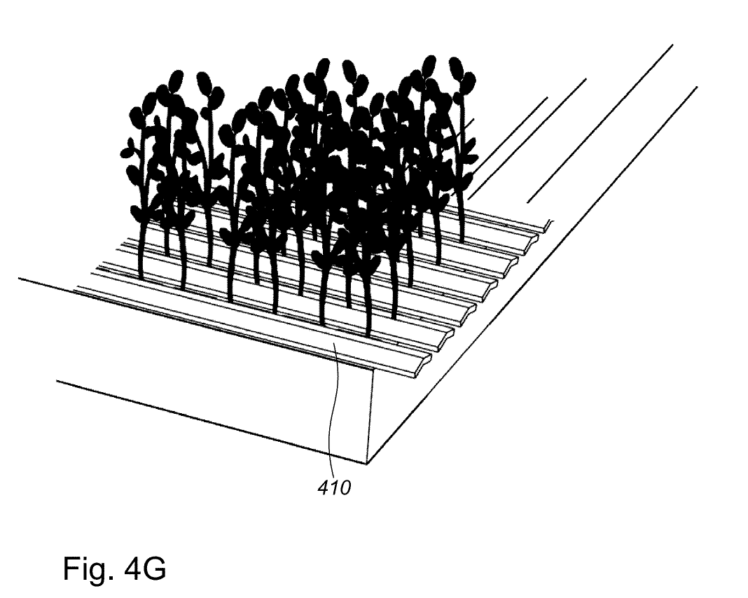

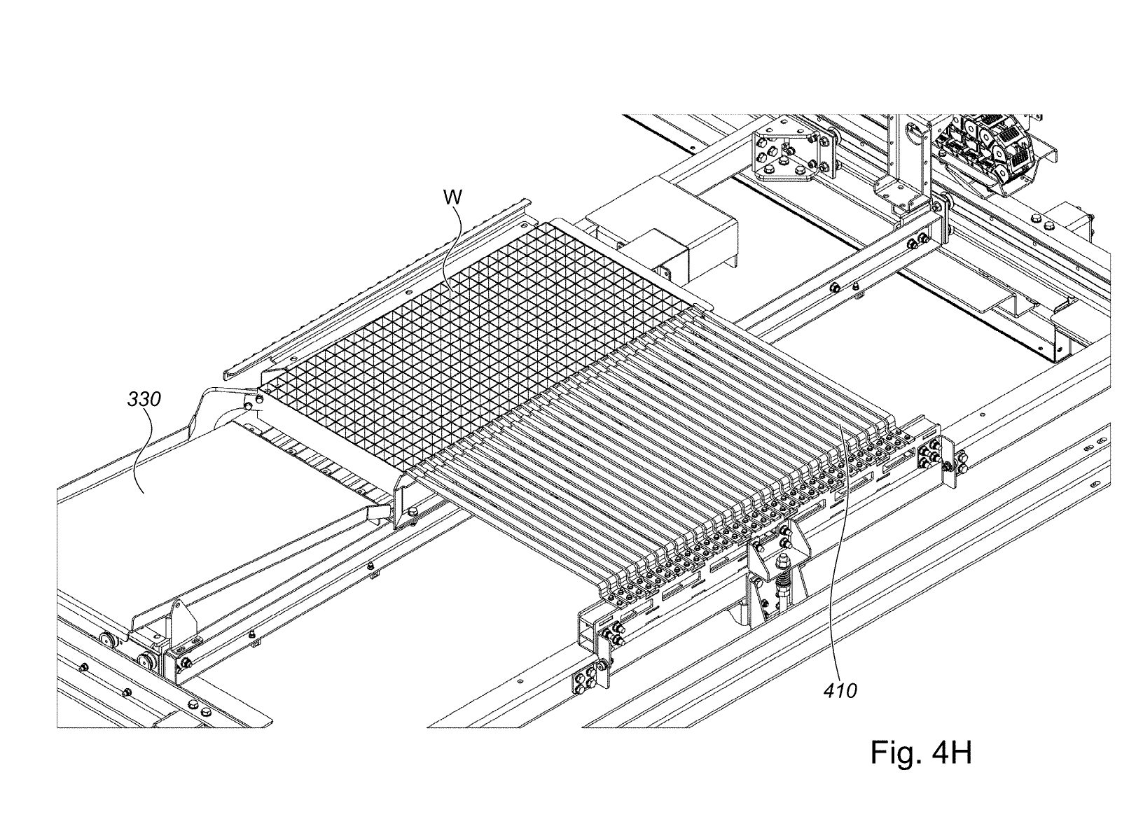

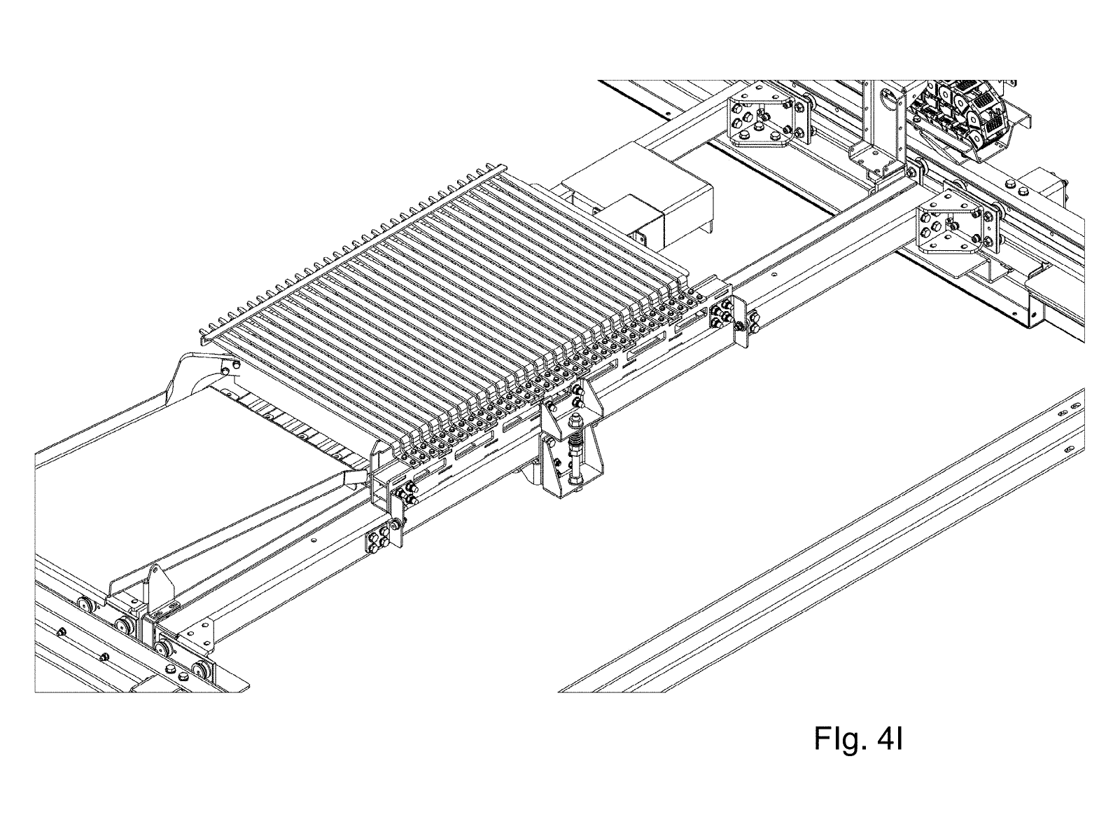

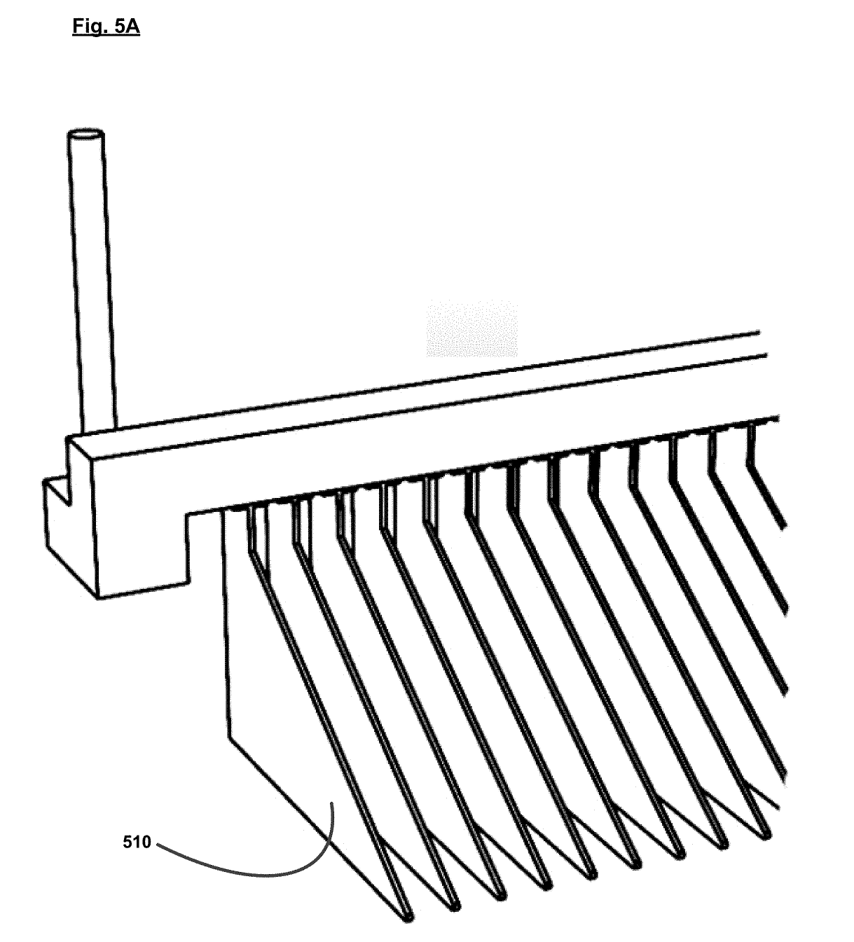

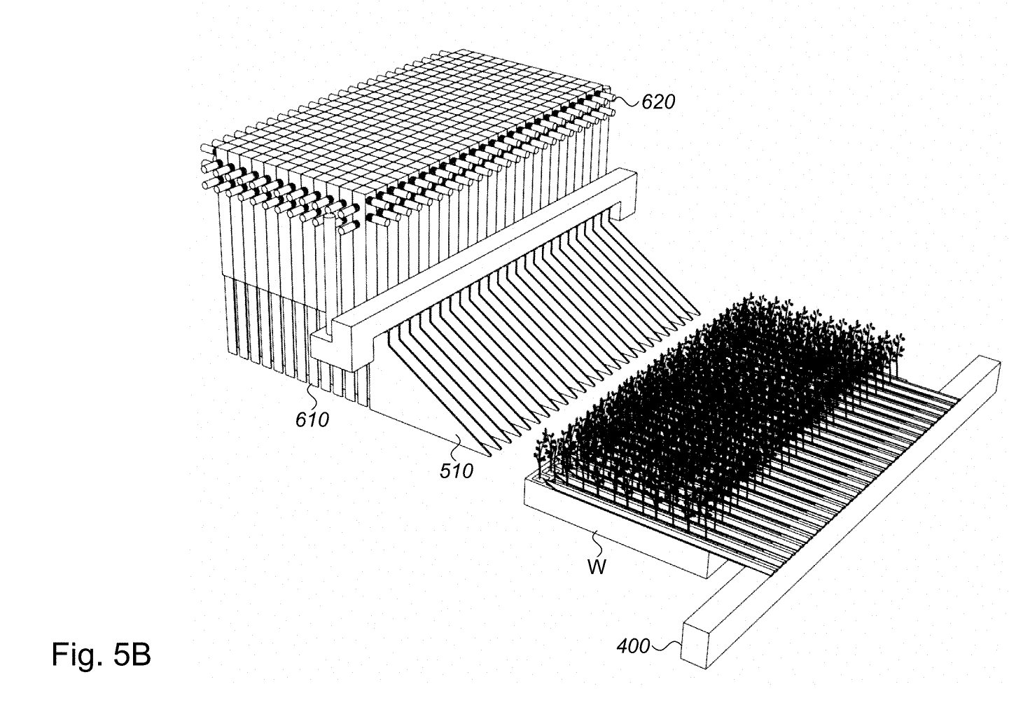

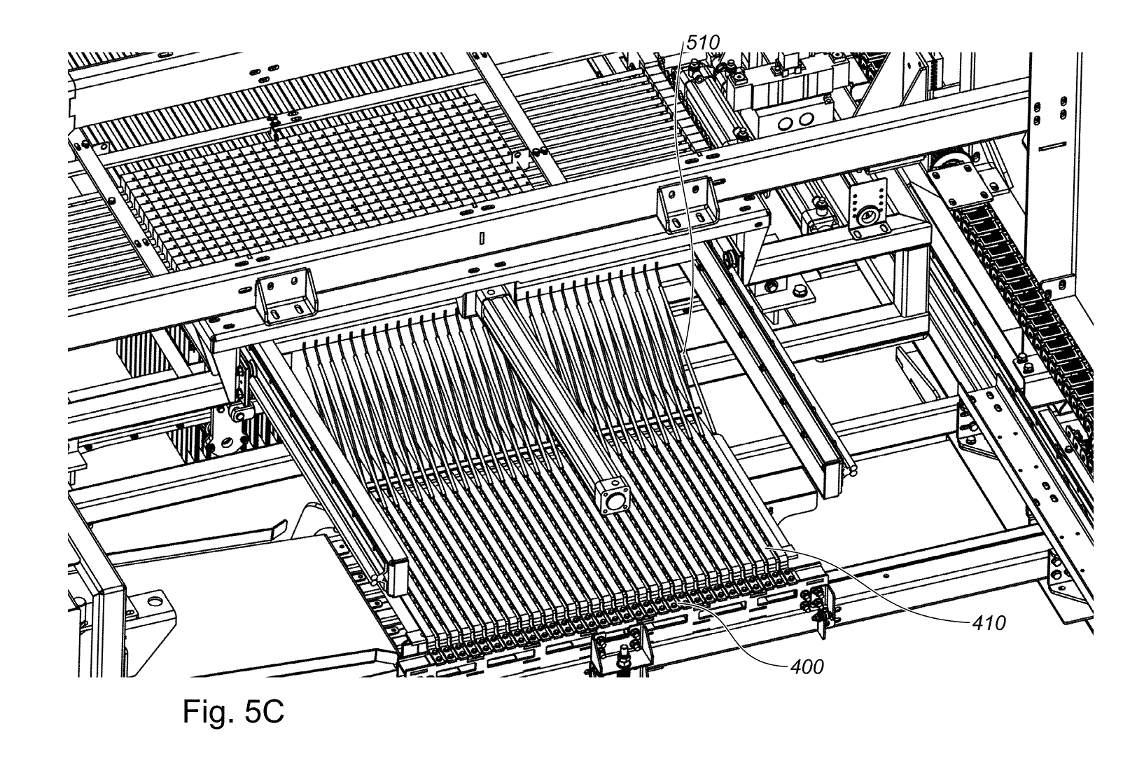

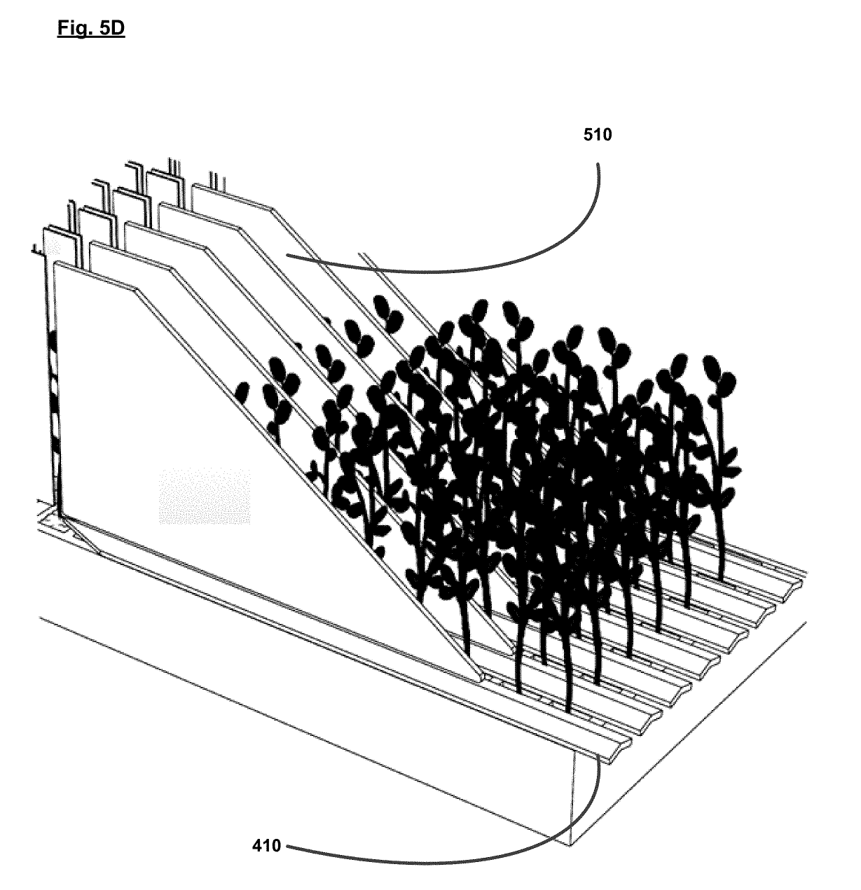

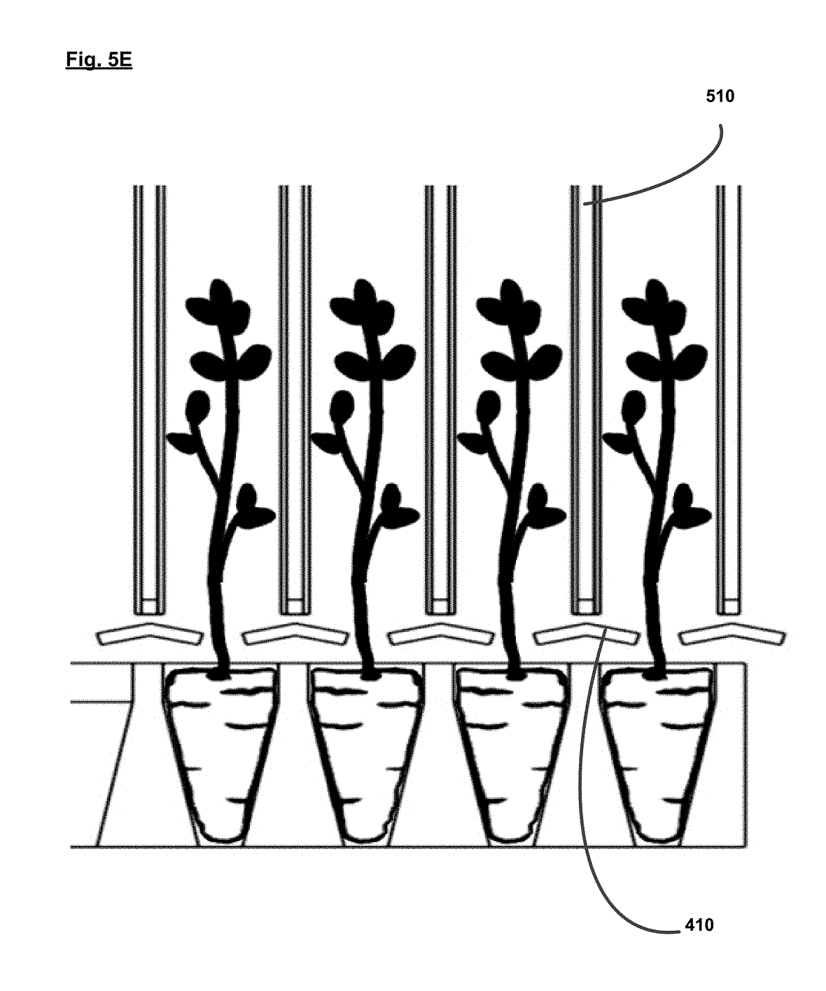

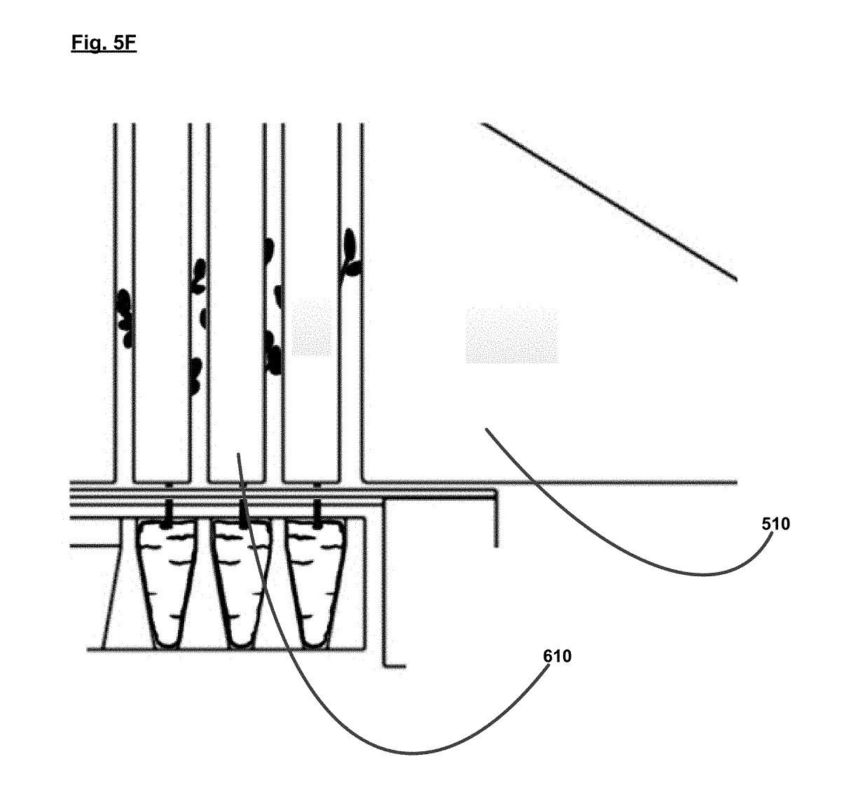

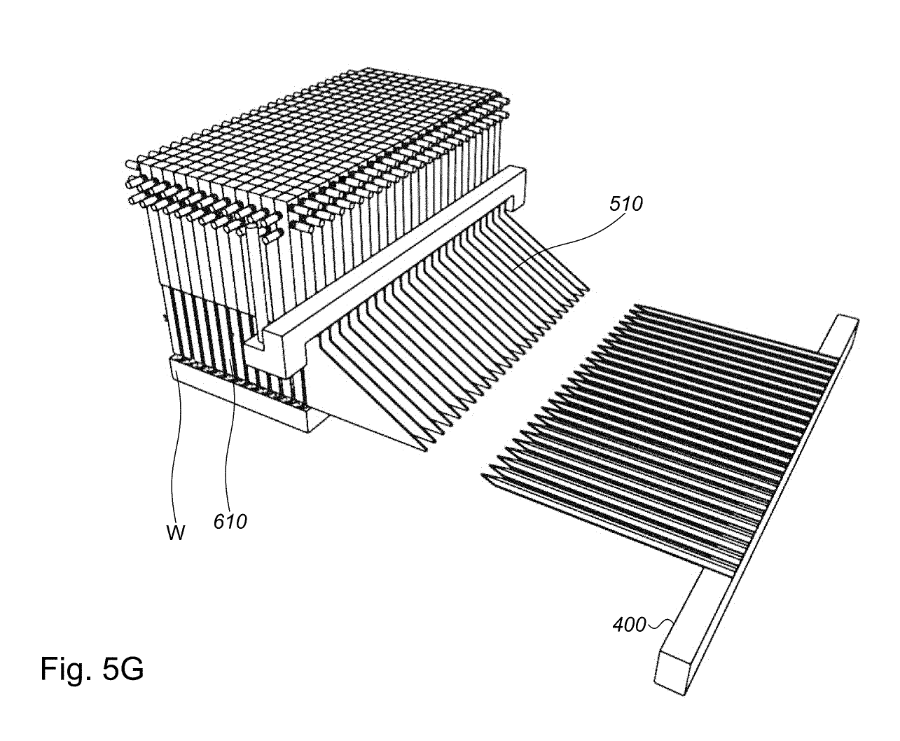

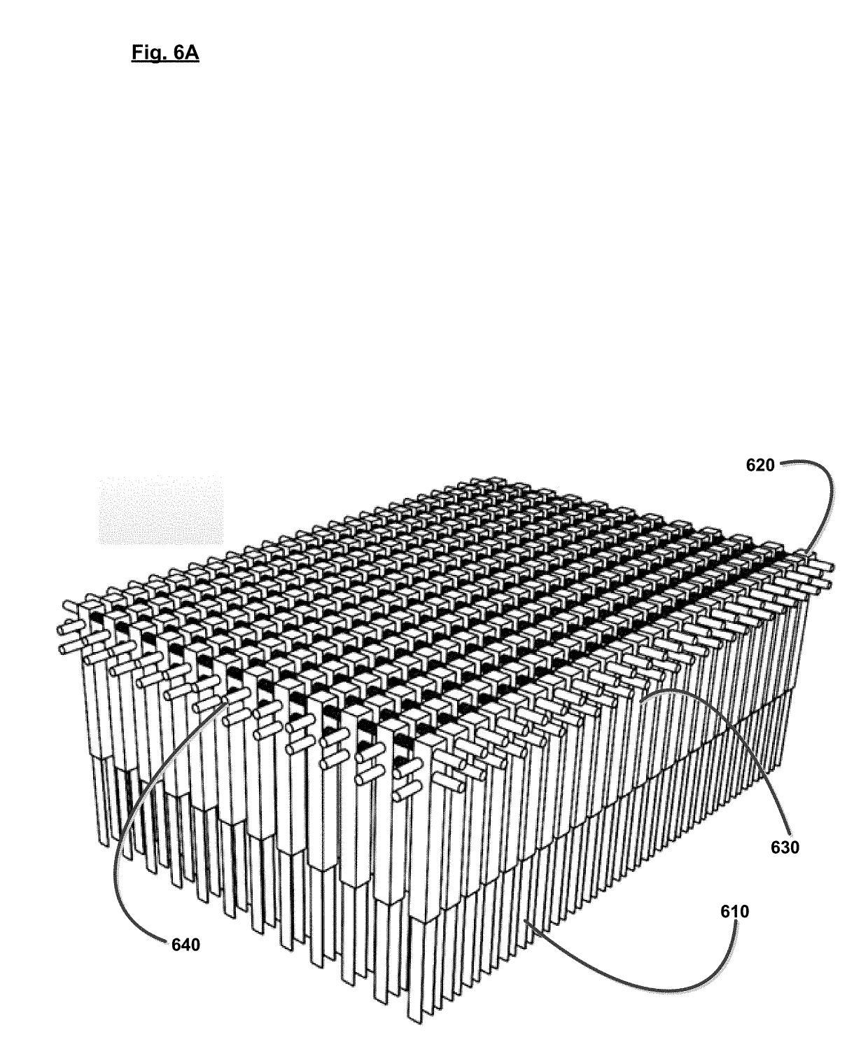

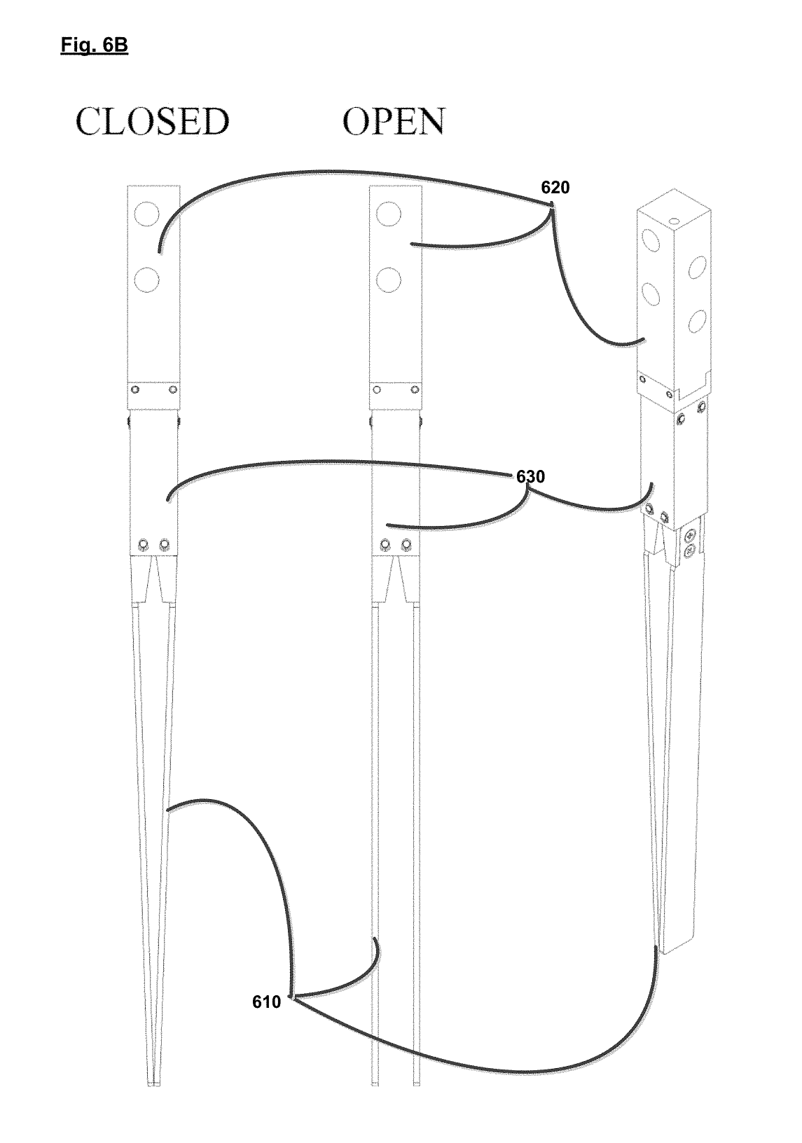

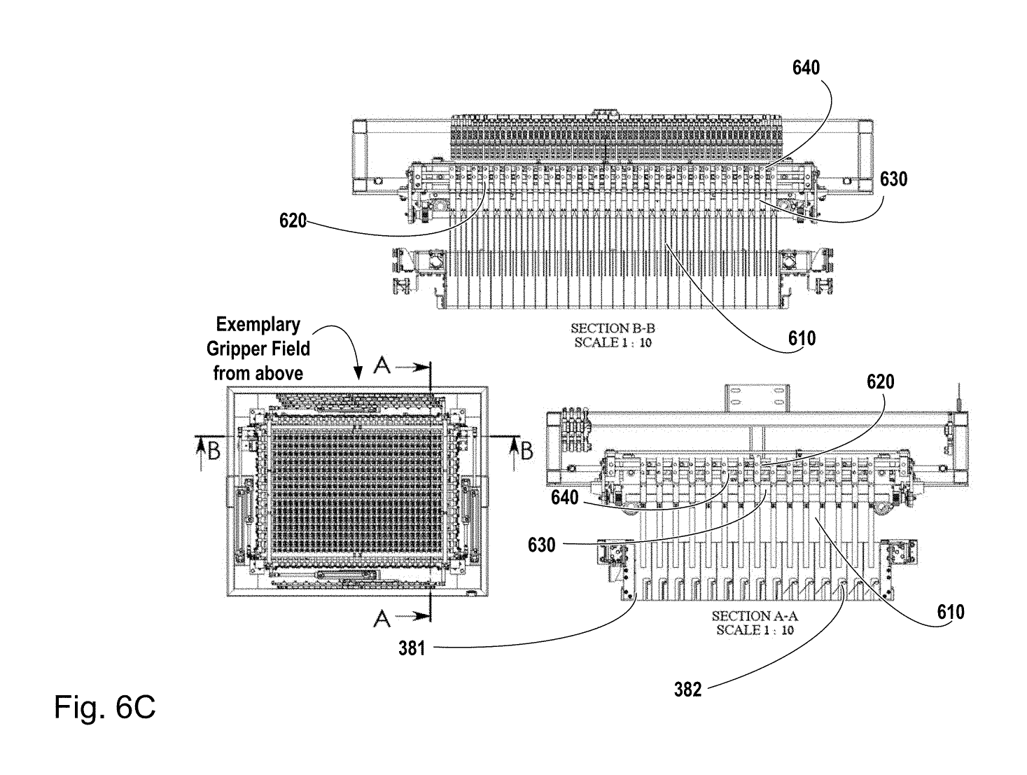

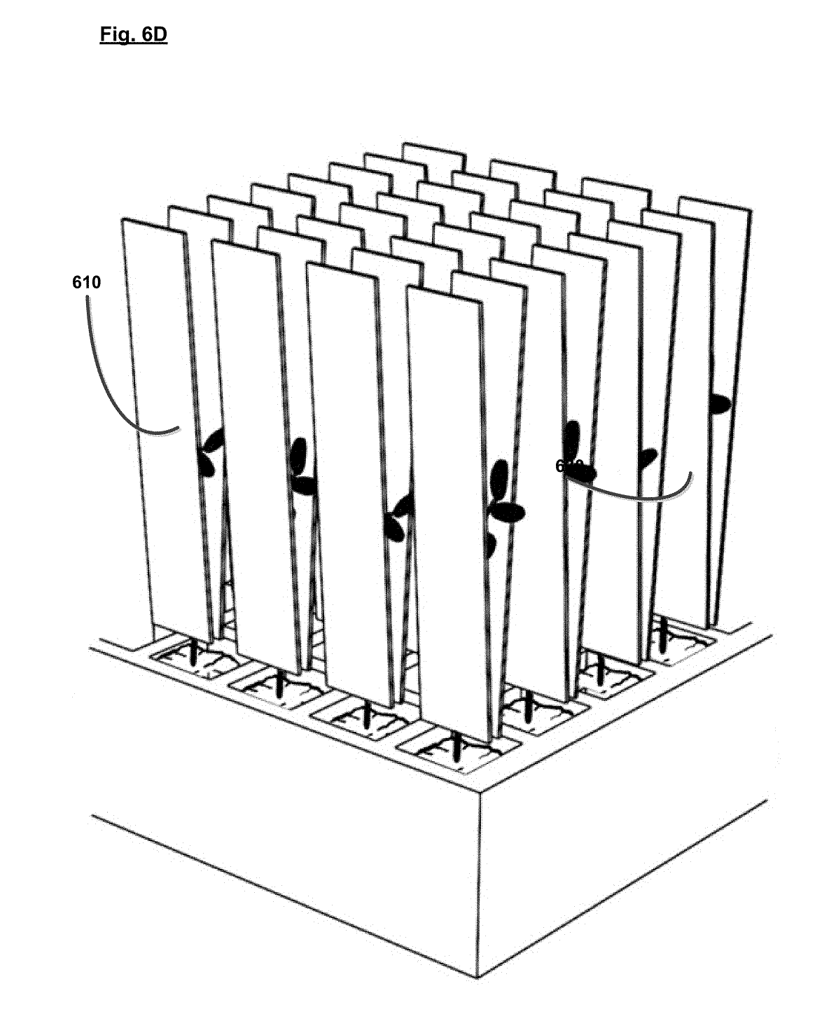

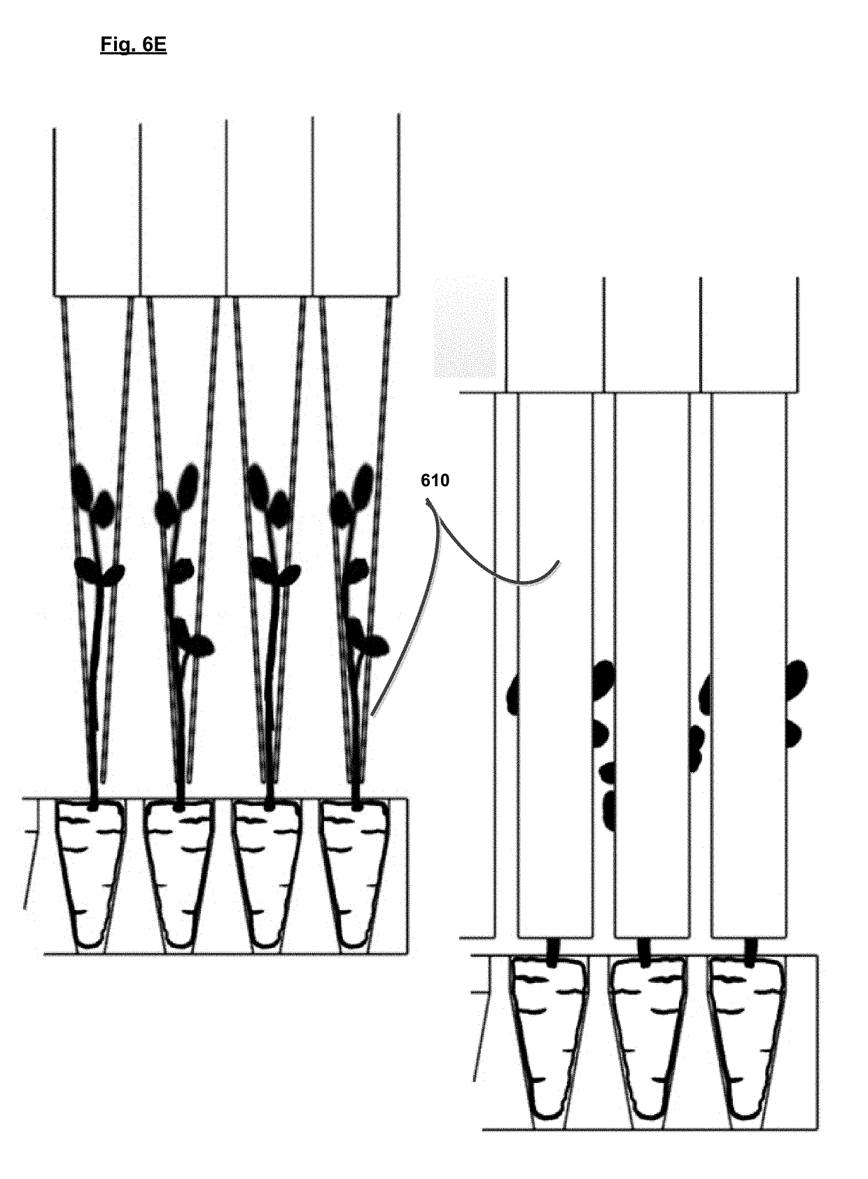

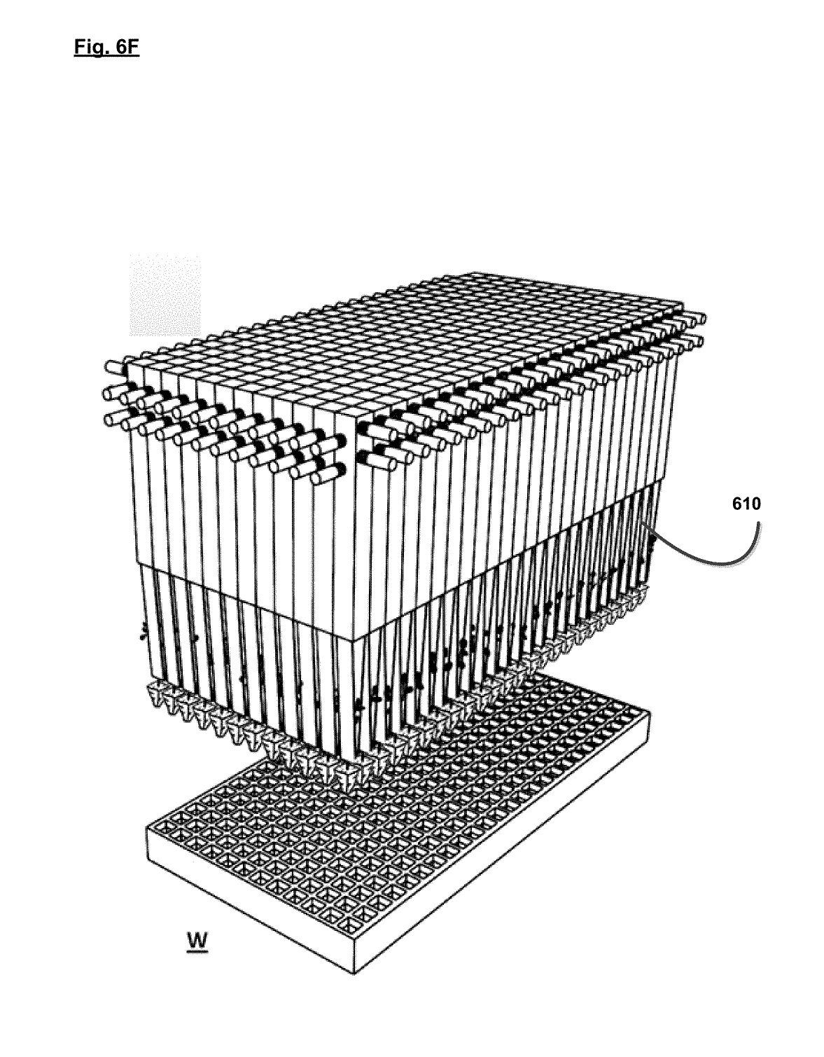

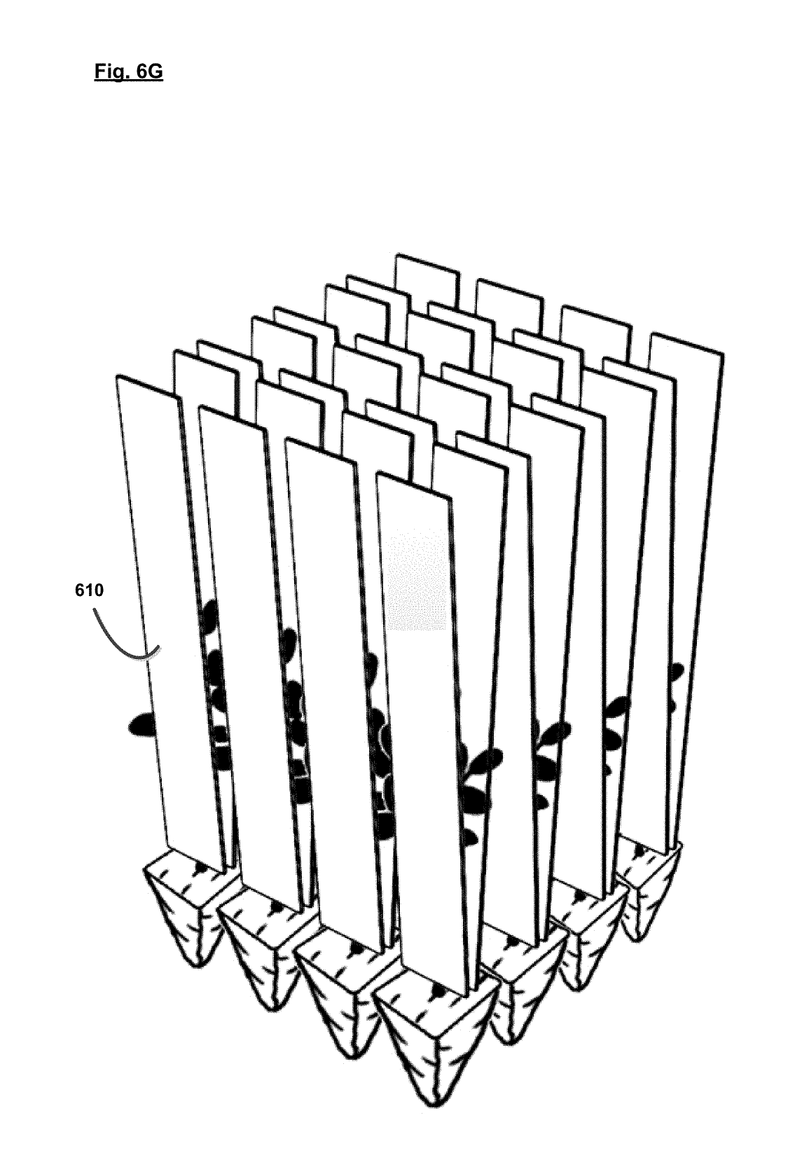

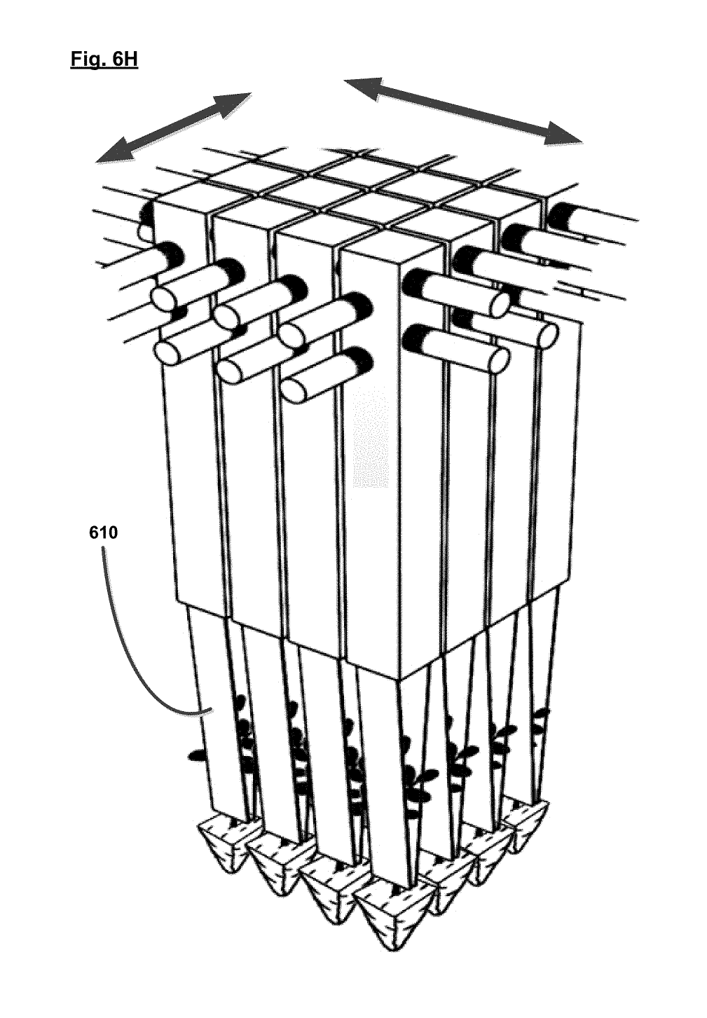

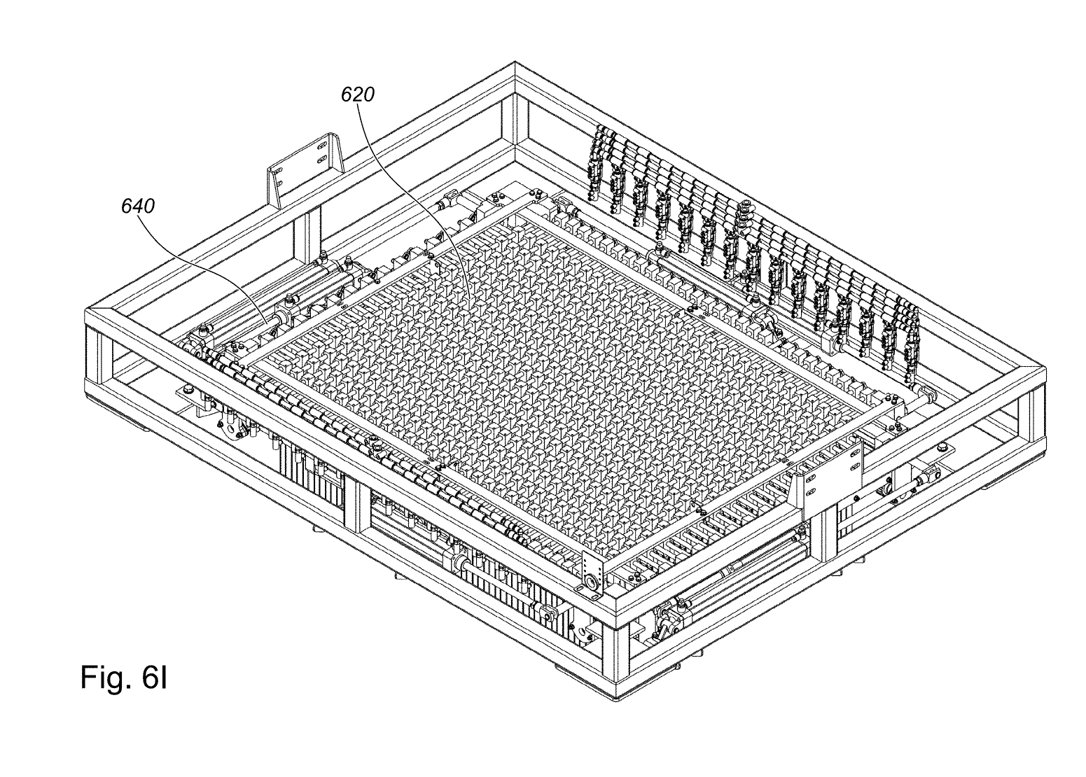

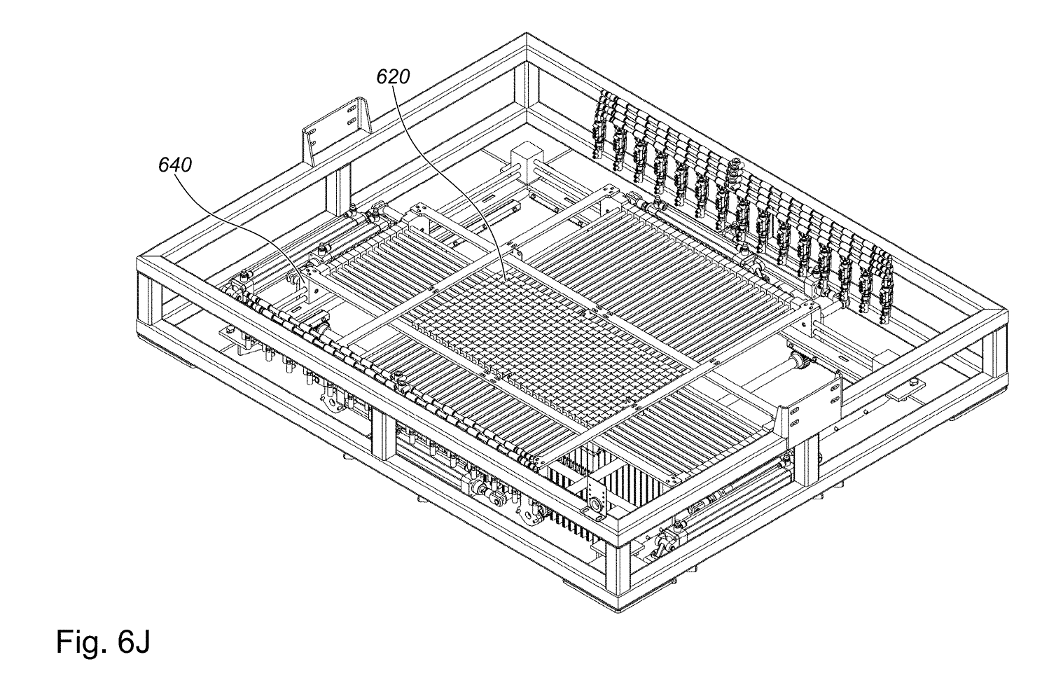

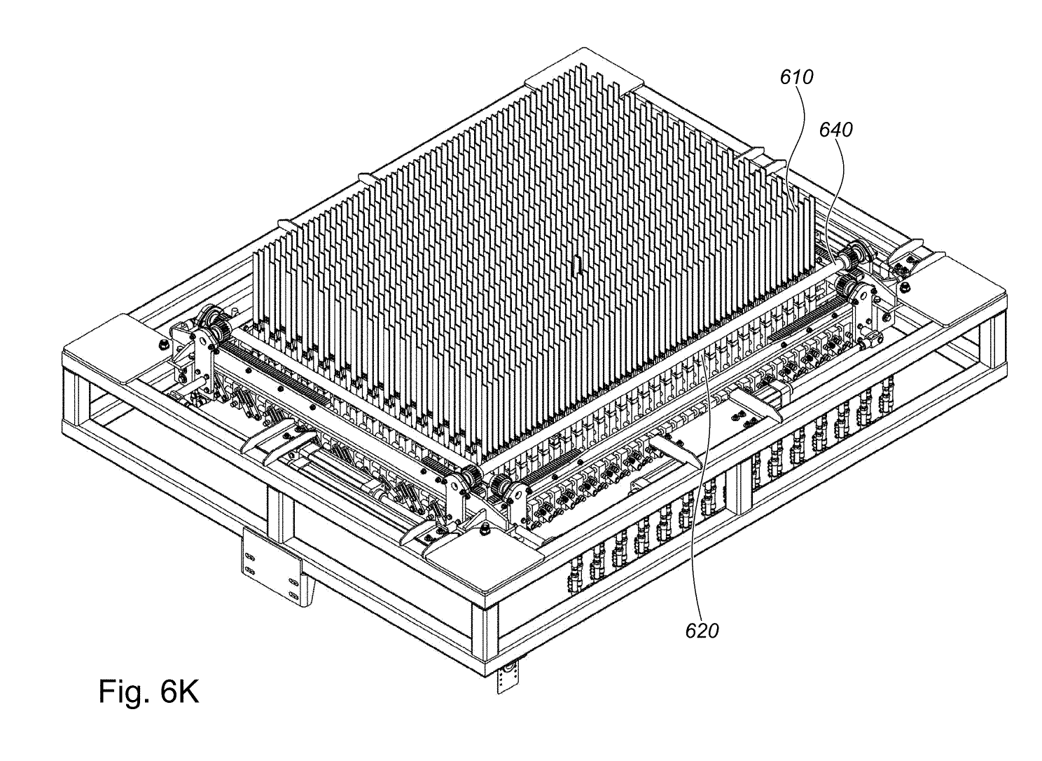

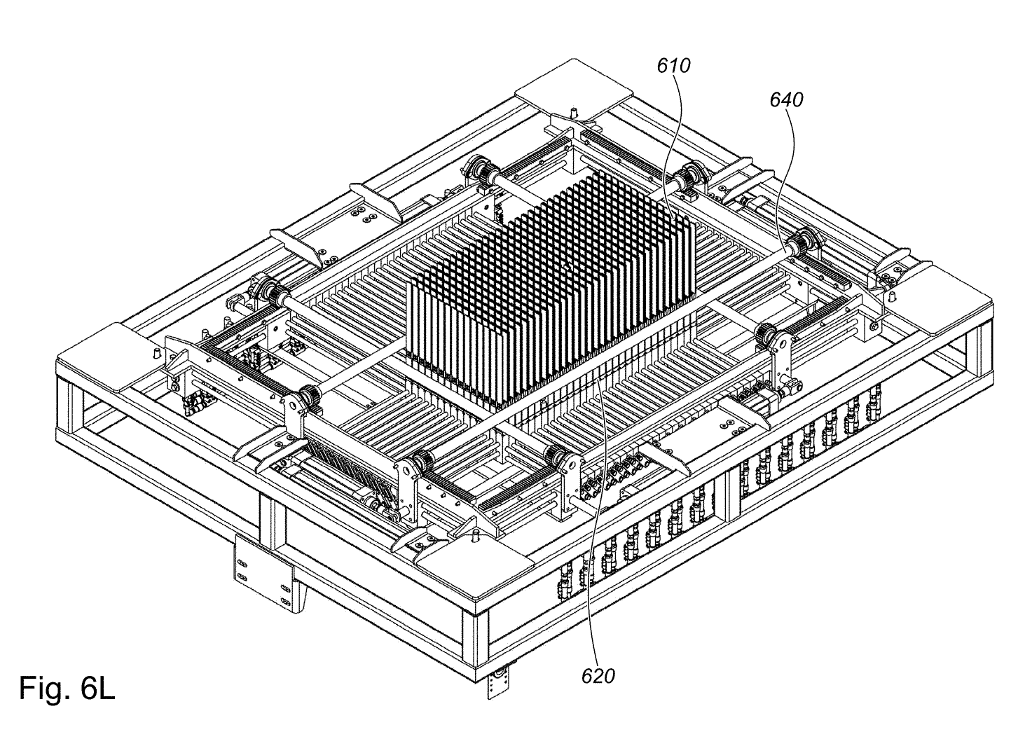

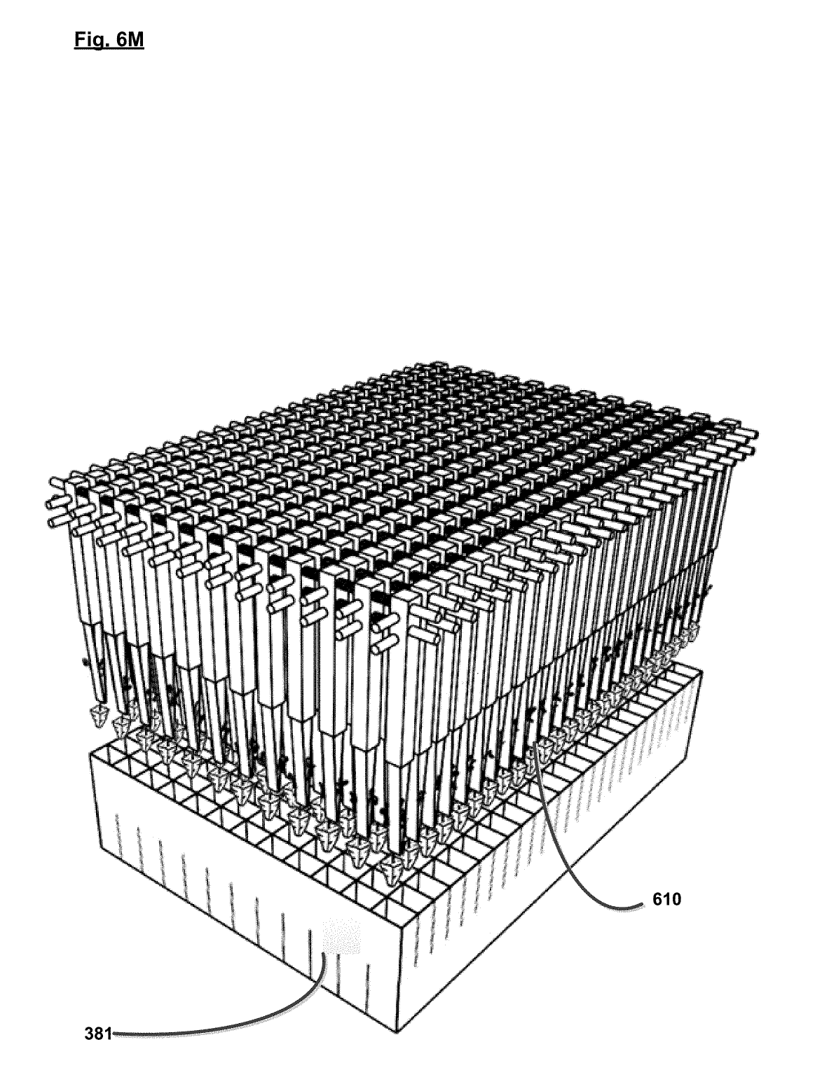

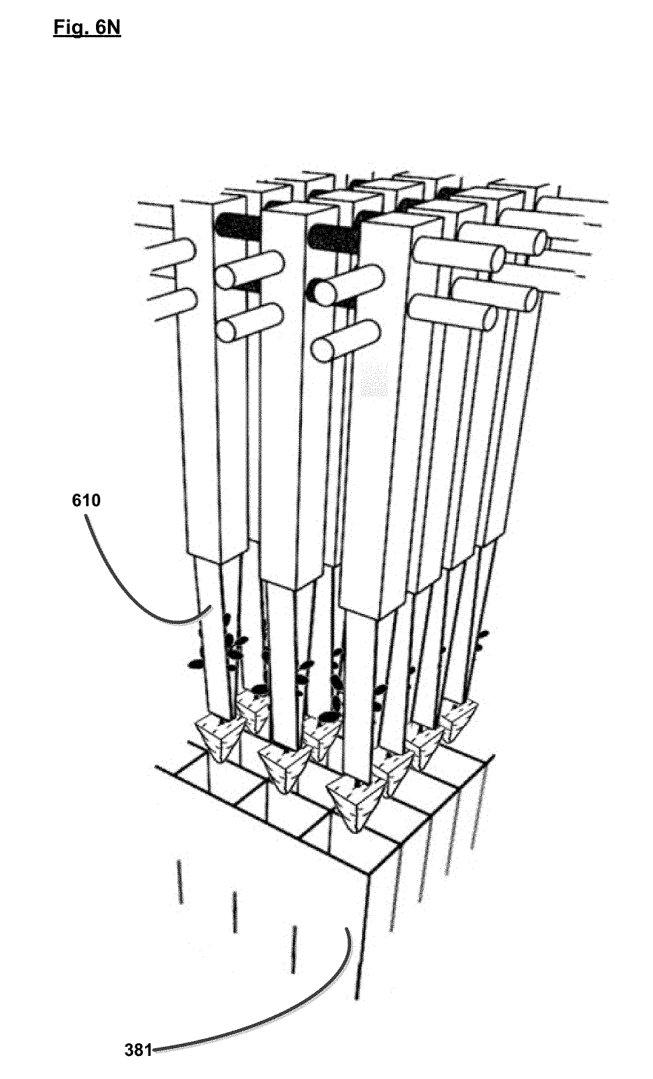

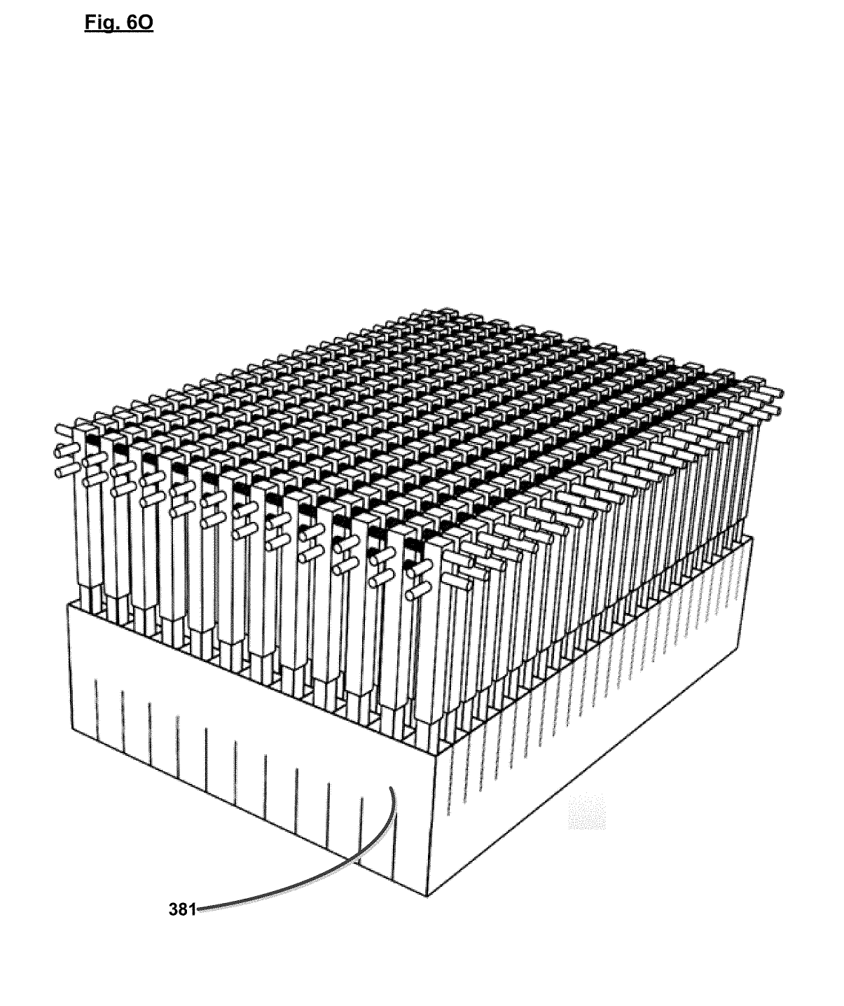

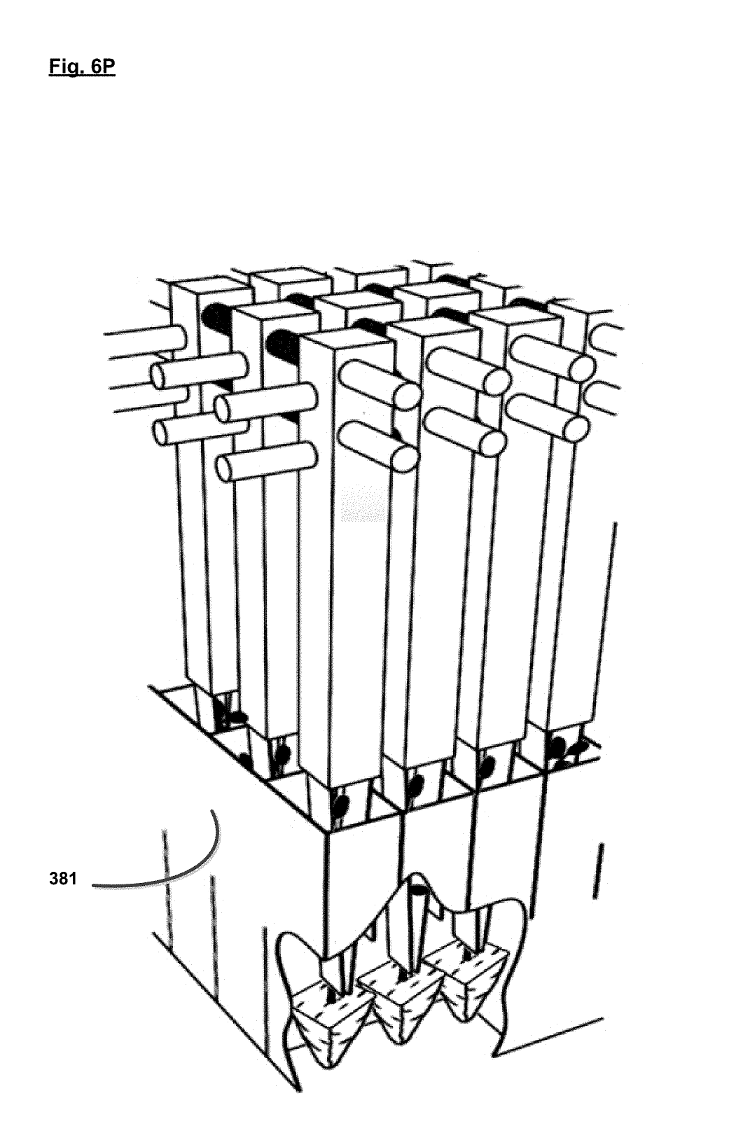

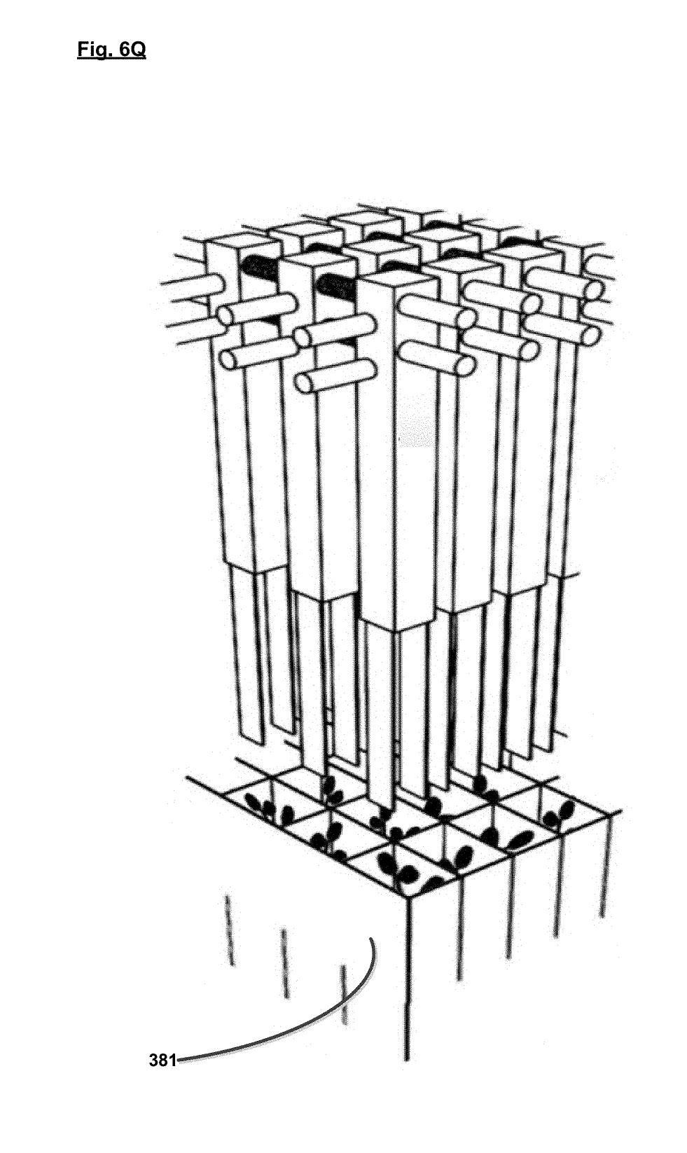

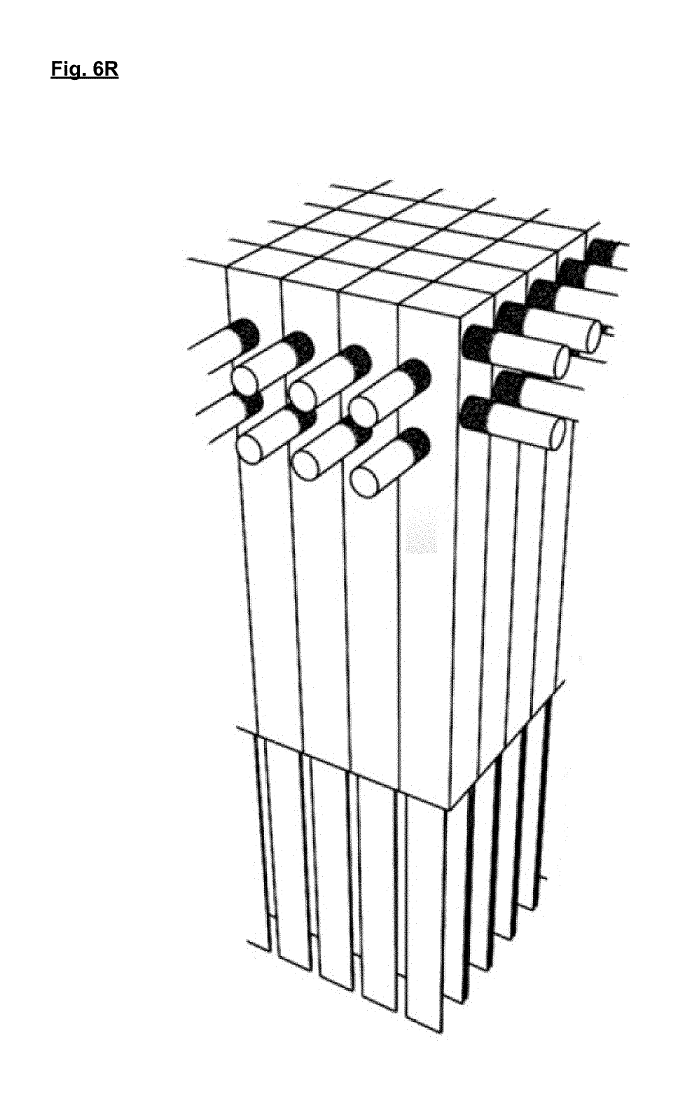

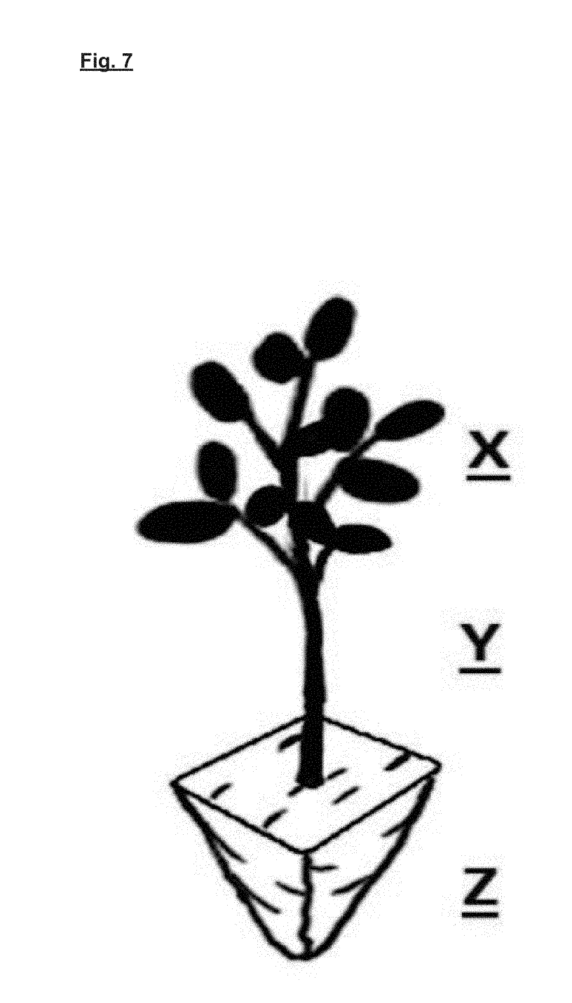

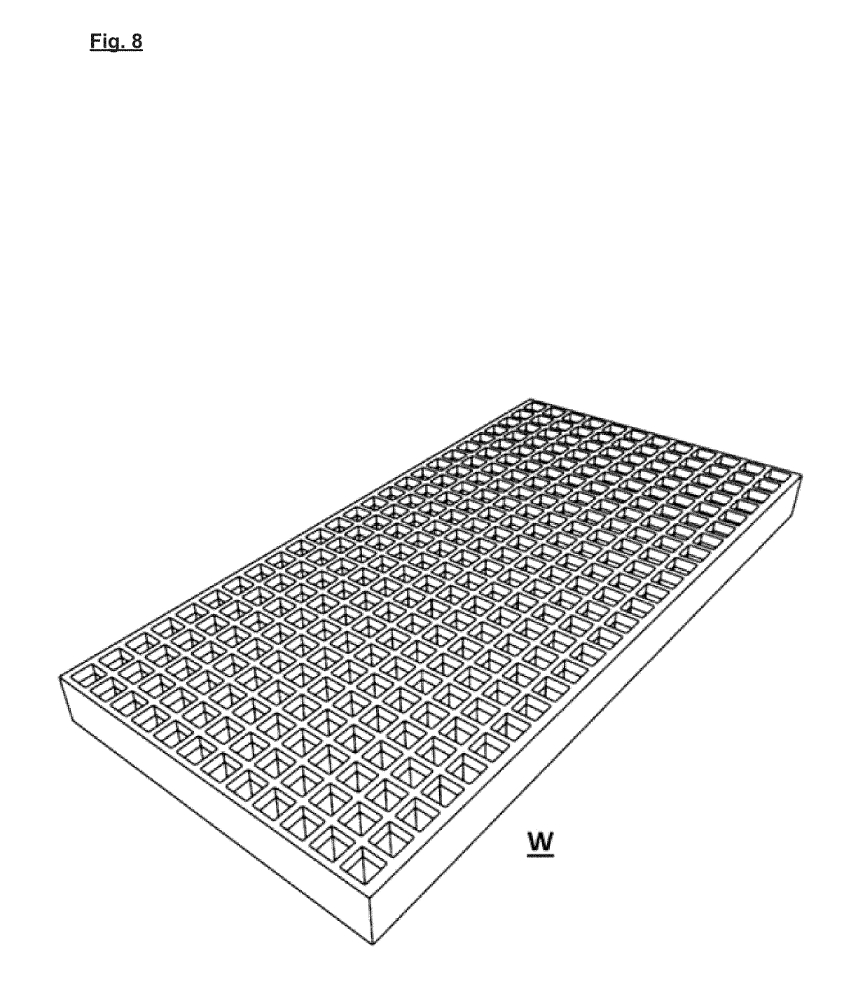

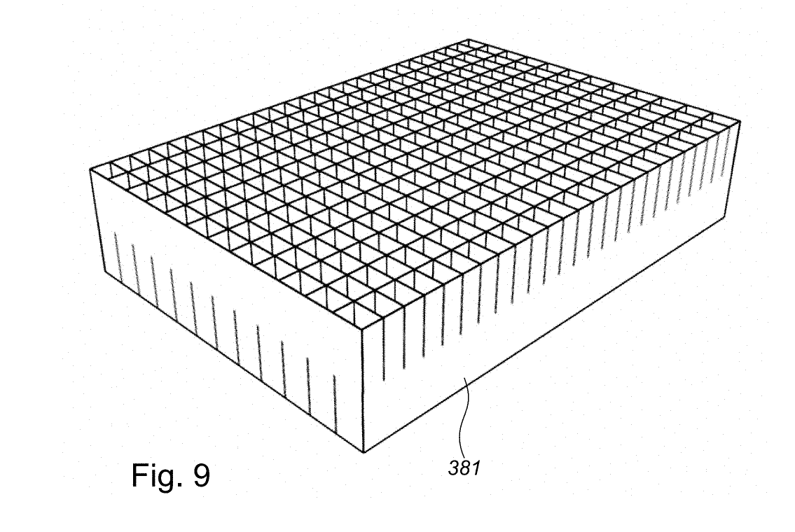

As can be seen in the figures, an exemplary subsystem for seedling withdrawal, respacing and deposit-in/transfer-to transitory trays may be comprised of:
a. a mechanism for receiving seedling trays and moving them into position (e.g. a sloped track (330));
b. an alignment module (400) to align the tray and stems of the seedlings and secure/hold the stems and/or root clumps/dirt in place. The alignment module may comprise alignment rods (410) designed to be inserted between the rows of stems of the seedlings in the tray. Aligned insertion of the rods between the stems may be accomplished by horizontally moving the alignment module towards the seedling tray while holding the tray in position, as shown in FIGS. 4A-4E. The alignment rods (410) may further be designed to hold seedlings and/or their “dirt clump” in place during the alignment and insertion of the below described dividers;
c. a dividing module comprising an array of vertical dividers (510) designed to separate seedling branches and leaves from neighboring rows. The dividers may be inserted between the rows by horizontally moving the dividing module towards and through the seedling tray while holding the tray in position (as shown in FIGS. 5A-5F);
d. an array of grippers (600) comprising pairs of opposing gripping arms (610) suspended from:
e. a grid of gripper supports (620) and actuators designed to sequentially:
   1. move the gripping arms into position to the sides of the stem of each seedling in the seedling trays (FIGS. 5F-5G);
   2. actuate the grippers to grip seedlings stems (FIG. 6D-6E);
   3. raise the grippers holding the seedlings (FIG. 6F);
   4. respace the seedlings by manipulating orthogonal horizontal rods (640) supporting the grid of gripper supports (FIGS. 6H-6L);
   5. lower and release the seedlings into transitory trays in the new spacing (FIGS. 6M-6Q).
it should be understood that movement of components described herein is often relative to each other and thus can be reversed in other embodiments. For example, movement of the alignment module or divider module towards a tray may be replaced in other embodiments with movement of the tray towards the relative component. Similarly, lowering or raising grippers can be replaced in other embodiments with raising and lowering the tray towards the grippers and so on . . . .

FIGS. 4A-4I shows exemplary alignment modules (400). As can be seen in the figures, the exemplary alignment modules are comprised of an array of parallel rods/bars (410), spaced between them such as to pass between rows of seedlings in seedling trays and: (i) secure the seedling stems in position, and/or (ii) secure the root chunks of the seedlings in position. FIGS. 4D-4I show insertion of an alignment module between rows of stems of seedlings in a seedling tray. FIG. 4C shows an exemplary alignment rod. As can be seen, alignment rods may have a pointed end to facilitate smooth insertion between seedlings. As can further be seen in the Figure, alignment rods may have a concave/“v-shaped” cross section. As shown in FIG. 4B, a threaded bar (420) passing through the base of the alignment module, or any other known mechanical actuator, may be used to push the alignment rods into position.

FIG. 5A shows an exemplary dividing module comprising an array of vertical dividers (510) designed to separate seedling branches and leaves from neighboring rows. As can be seen in FIG. 5A, the exemplary dividing module is comprised of an array of parallel slanting vertical barriers (510), spaced between them such as to pass between rows of seedlings in seedling trays and separate their branches from seedling of neighboring rows. FIGS. 5D-5E show insertion of a dividing module between rows of stems of seedlings in a seedling tray.

As can be seen in FIG. 5F, the dividing module may be positioned in front of an array of suspended grippers (a gripper “field”) positioned in rows behind the dividers. FIGS. 5C-5F show, in accordance with some embodiments of the present invention, a scheme of an exemplary process of horizontally mobilizing the Aligning Rods Module to align the Stems/Stalks (middle sections) of the Seedlings in each of the rows, while retaining the Root Chunks (bottom sections) of the Seedlings, for vertically lowering the Sloping Dividers Module to a position adjacent to the Gripping Arms Module, and for them to collectively travel horizontally while separating the Branches/Twigs of the Seedlings in each of the rows, while the Aligning Rods Module prevents the premature or unintentional withdrawal of the Seedlings by retaining their Root Chunks.

FIG. 6B shows an exemplary gripper and its operation according to some embodiments of the present invention. As can be seen in FIG. 6B, the exemplary gripper is comprised of a pair of parallel arms/rods, suspended from a rectangular support and actuator. This particular example is pneumatic. As can further be seen, the gripper is open when the pair of suspended arms/rods are parallel and closed (i.e. “gripping”) when the ends of the arms/rods are forced together (like pincers) to grip a seedling stem positioned between the ends of the gripper arms/rods. FIGS. 6A and 6C show an array/“field” of grippers from different angles. FIG. 5F shows insertion of the exemplary gripper array between rows of stems of seedlings in a seedling tray. As can be seen, the gripper arms in their open state enter between the rows of seedlings behind the sloping dividers, the dividers clearing the way from any obstructions.

Once the grippers are in position, they may be actuated to “grip” the seedlings by their stem, as shown in FIGS. 6D-6E. The grippers may then be raised, as shown in FIG. 6F, gently withdrawing the seedlings from the seedling tray. Before raising the grippers, the alignment rods need to be withdrawn, as shown in FIG. 5G.

Once the seedlings are withdrawn from the tray and suspended by the grippers, they may be respaced by manipulating the gripper supports. As can be seen in FIGS. 6H-6L, the gripper supports may in turn be supported and positioned by arrays of orthogonal rods (640), passing through holes in each gripper support. The rods may include a thread (helical ridge) matching/mating—with threads within the respective holes in the gripper supports, such that rotation of the orthogonal rods can be used to manipulate the positions of the gripper supports and thus respace the grippers.

Once the seedlings have been respaced, the grippers may be maneuvered over first transitory trays (381) having cells matching the new spacing, as shown in FIGS. 6M-6N. The seedlings may then be released into the first transitory trays, as shown in FIG. 6O.

### The “Middle” Subsystem

### Receiving Transitory Trays of Seedlings and Feeding One by One to an Automated Planter

The second subsystem (220—the “middle” subsystem) may receive the first transitory containers of seedlings from the top subsystem.

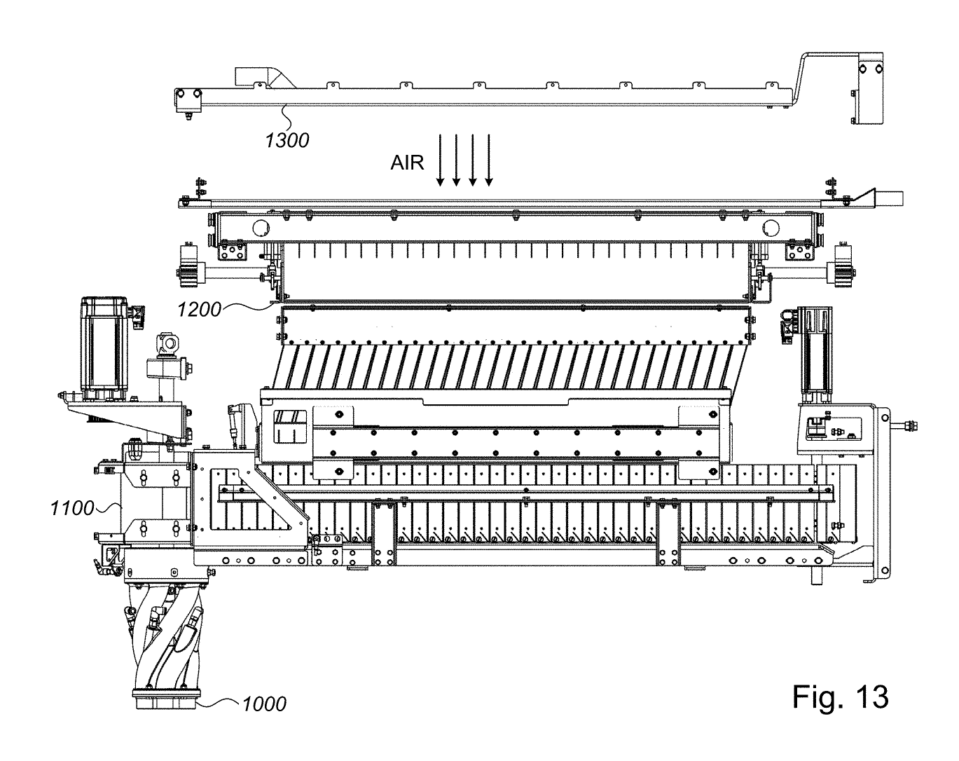

According to some embodiments, as can be seen in FIG. 6C, the first transitory trays may include openings in the bottoms of the seedling cells, allowing seedlings to be inserted from the top of the cells by the grippers and subsequently forced through the bottom of the cells by air pressure produced by a pneumatic system. According to further embodiments, seedling cells in the first transitory trays may include “trap doors” (382) in their bottoms to support seedlings within the cells. For example, the seedlings may be subsequently transferred to second transitory trays by positioning a row of cells of the second transitory tray beneath a row of cells of the first transitory tray and applying air pressure from above, as shown in FIG. 13. In this exemplary embodiment, this process is accomplished by an air “knife” (1300), which is a linear aperture of air flow. First transitory tray passes beneath the air knife, row by row (or 3 by 3), while the second transitory trays each move into position below, on que to receive seedlings forced through the bottom of the first transitory tray by the air knife. As can be seen in FIG. 6C, trap doors held in place by springs or other mechanical mechanisms, support the seedlings in the cells until they are forced downward by the air pressure.

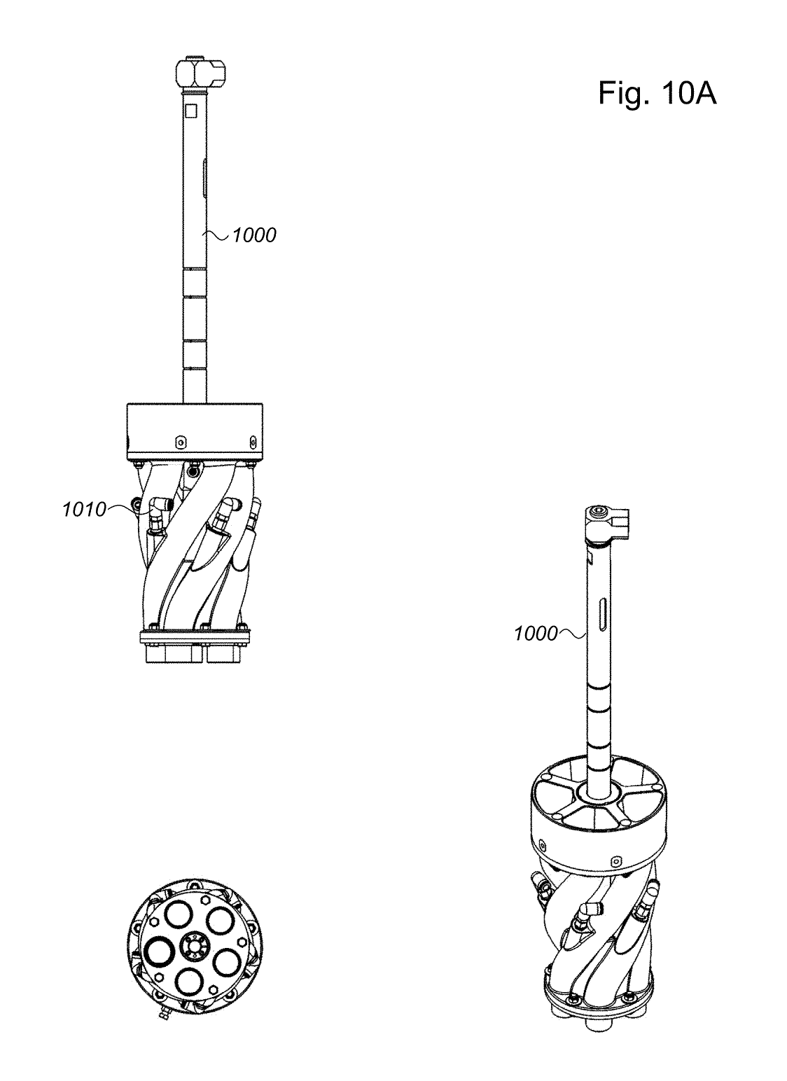

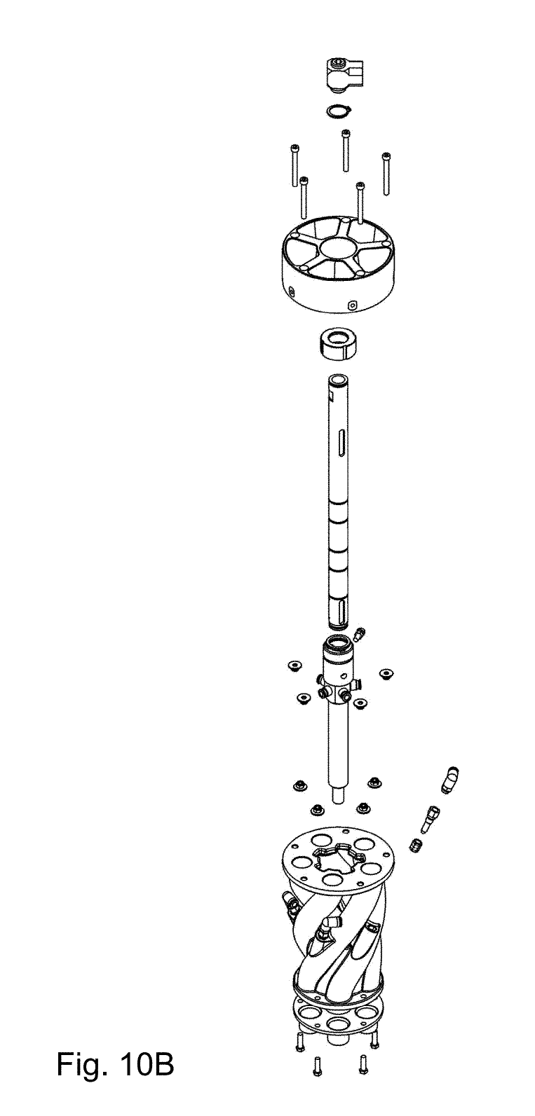

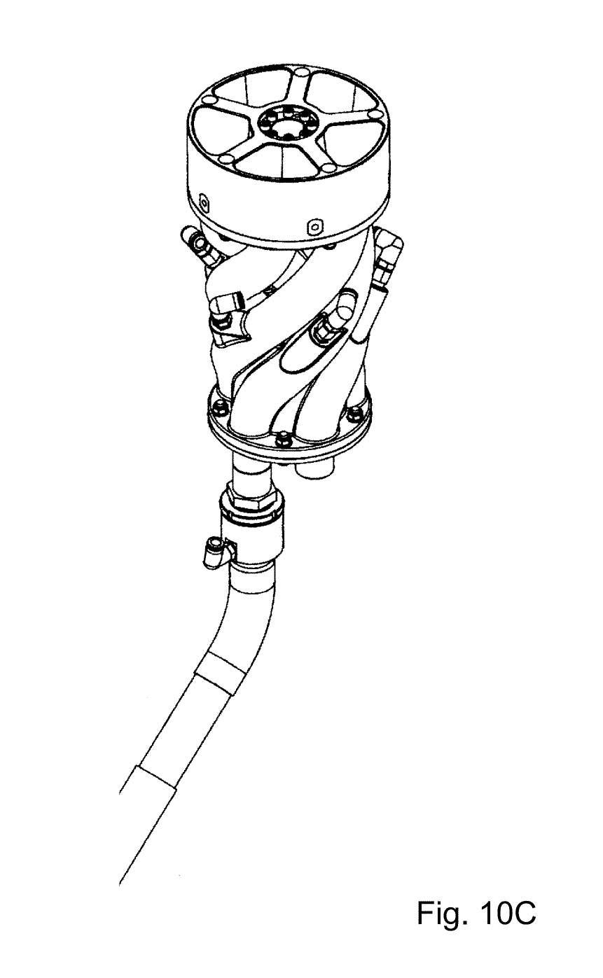

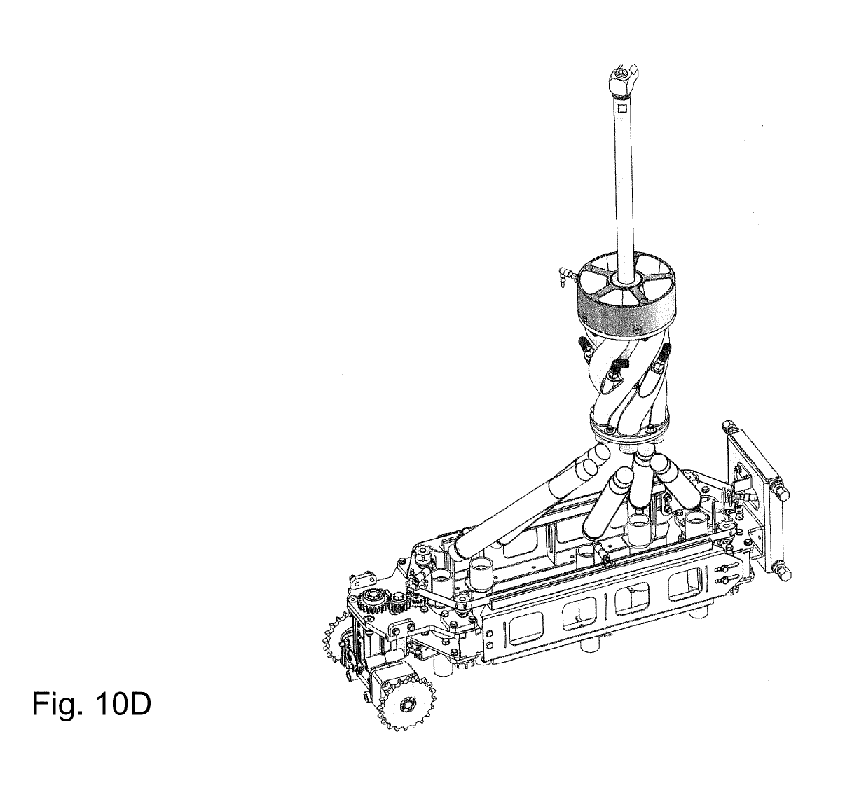

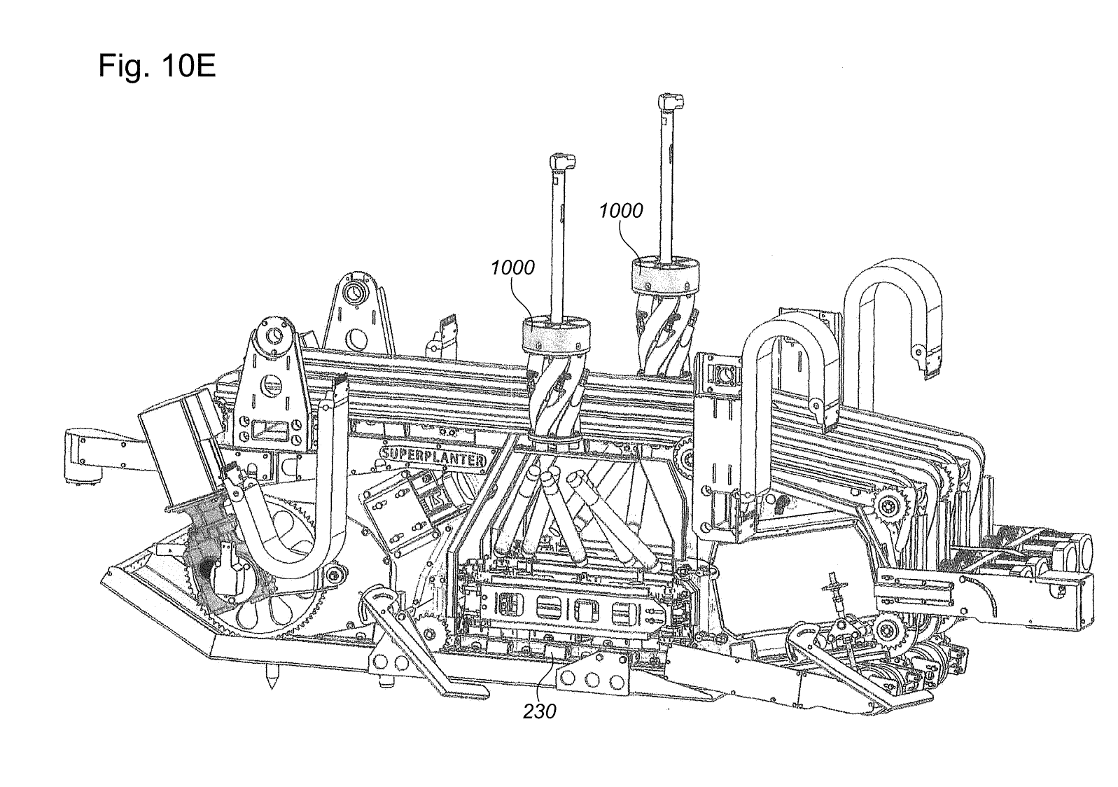

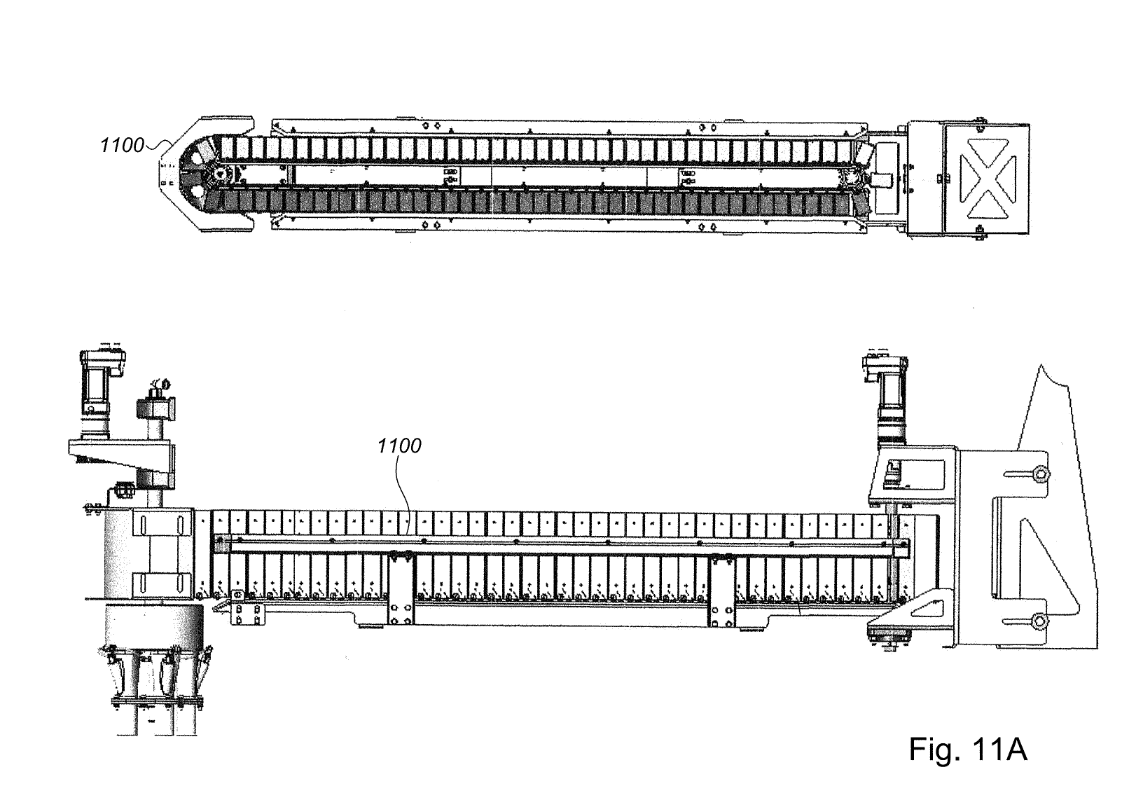

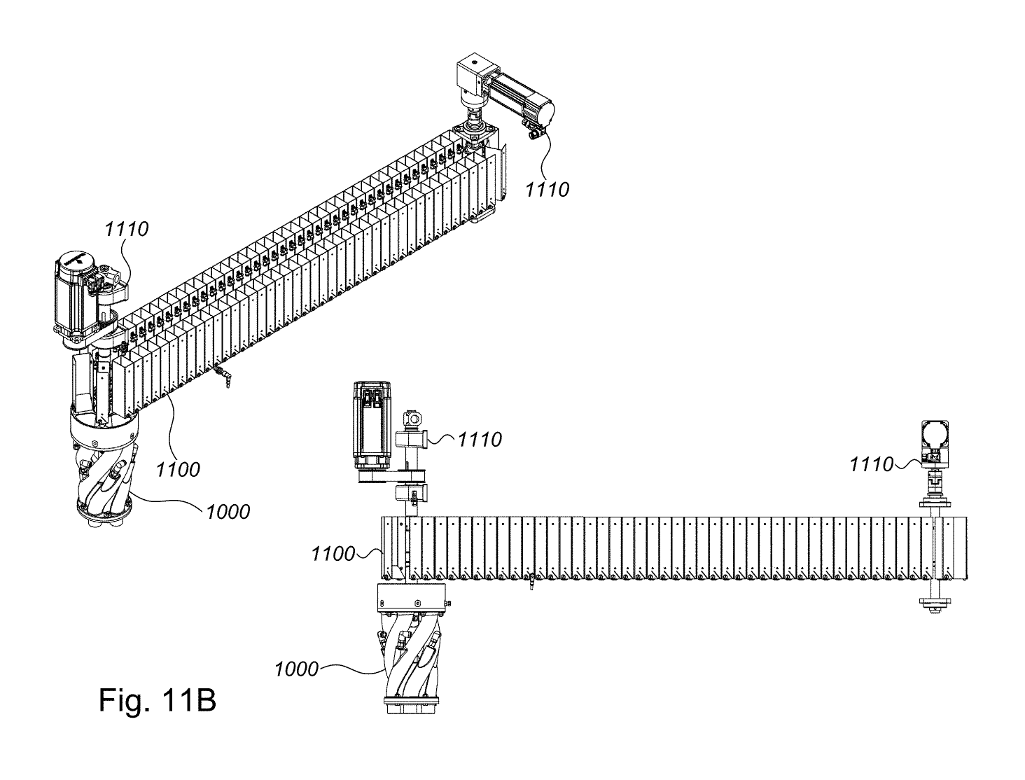

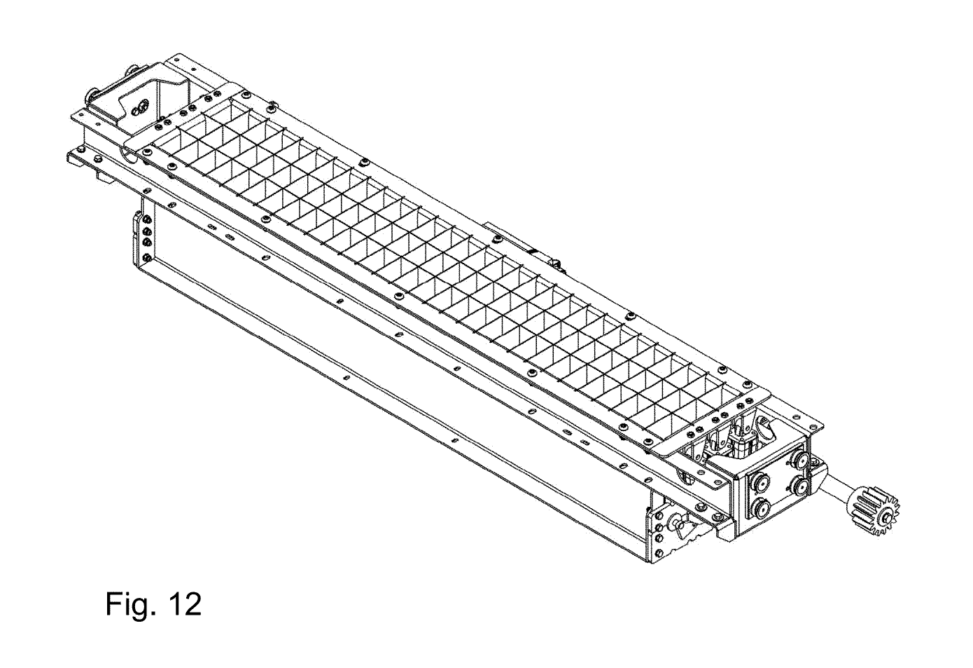

The second subsystem (230—the “middle” subsystem) may subsequently transfer the seedlings from the second transitory trays (1200—shown in detail in FIG. 12) to a conveyer belt of seedling containers (1100—shown in detail in FIGS. 11A-11B) or any other moving sequence of containers for individual seedlings. The second subsystem may further include a seedling dispenser (1000—shown in detail in FIGS. 10A-10E) designed to timely dispense seedlings from the conveyer belt of seedling containers into chutes reaching a third subsystem (230—the “bottom” system) designed to plant the seedlings, as shown in FIG. 10E

As shown in FIG. 10A-10C, the seedling dispenser may comprise a circular collection of seedling tubes, arranged in a circle to release seedlings into tubes leading to the planting subsystem in a time manner. As shown, the tubes may be twisted around the dispenser to improve velocity control and thereby improve timing.

As can further be seen, according to some embodiments, the seedling dispenser may further include air based control of the seedling transfer and velocity (1010).

According to some embodiments, a sensing subsystem may be implemented to sense the presence of seedlings within the containers in the conveyer belt, or lack thereof. A controller of the system may accordingly adjust the movement of the conveyer belt and operation of the dispenser to “skip” empty containers, thereby preventing “misses” in the planting. An example of such a sensing subsystem is shown in FIGS. 11A-11B. As can be seen, sensors (1110) positioned on the ends of the conveyer belt sense the presence (or lack thereof) of seedlings in each cell of the conveyer belt. A controller of the conveyer belt can accordingly adjust movement of the belt to “skip” empty cells and thereby avoid “misses” in planting. According to some embodiments, these sensing systems may include more complex sensors and/or more complex analytics to also sense other malfunctions, such as a seedling “stuck” in a cell, a damaged seedling, a seedling positioned incorrectly and so on. The controller may again adjust movement of the belt to “skip” the problematic cells and thereby again avoid “misses” in planting. The controller may also be adapted to issue alerts and notifications of the sensed problems and/or enact automated resolutions (e.g. a discharge of a damaged or incorrectly positioned seedling).

An example of the third subsystem (xx—the “bottom” system) designed to plant the seedlings can be found in U.S. Pat. No. 4,765,260, titled “Machine for Planting Seedlings”, filed by one of the inventors of the present Application on May 22, 1987, which is hereby incorporated by reference in its entirety into the present Application.

According to some embodiments of the present invention, a system apparatus and assembly for facilitating automatic planting may adapt between various dimensions, configurations, characteristics and/or arrangements of: Plants Trays, Planting System Magazines, and/or Seedlings/Plants.

According to some embodiments of the present invention, a system, an apparatus, and/or an assembly for facilitating automatic planting may comprise: (1) an Aligning Rods Module (400) for lining up Seedlings hosted in two or more rows of a Plants Tray [W]; (2) a Sloping Dividers Module for separating between hosted Seedlings rows; and/or (3) a Gripping Arms Module (600) including: (i) a Gripping Arms Grid for: (a) retaining the separation between hosted Seedlings rows, when the arms are in an open position; and/or (b) separately gripping each of the Seedlings contained in the Plants Tray when arms are closed, and releasing the gripped Seedlings in a Planting System Magazine when arms are opened; and (ii) a Gripping Arms Actuators Grid for: (a) activating the opening and closing of the Gripping Arms; and/or (b) vertically raising the Gripping Arms Module, to withdraw gripped Seedlings from the Plants Tray, and vertically lowering the Gripping Arms Module to introduce the withdrawn Seedlings into the Planting System Magazine; and/or (c) extending and spreading out the Gripping Arms Grid (furthering the Gripping Arms away from each other), and contracting and shrinking the Gripping Arms Grid (bringing the Gripping Arms closer to each other)—to accommodate between various dimensions, configurations, characteristics and/or arrangements of: Plants Trays, Planting System Magazines, and/or Seedlings/Plants.

According to some embodiments of the present invention, an automatic planting process executed by a system, an apparatus, and/or an assembly for facilitating automatic planting, may include:

(1) Horizontally mobilizing the Aligning Rods Module (400) over one or more linear mobilizers towards the Plants Tray, and penetrating with the rods into substantially the center of each of the gaps between the rows of the Seedling.

(2) Further horizontally mobilizing the Aligning Rods Module (400) to align the Stems/Stalks (middle sections) of the Seedlings in each of the rows, while retaining the Root Chunks (bottom sections) of the Seedlings.

(3) Vertically lowering the Sloping Dividers Module to a position adjacent to the Gripping Arms Module (600), such that each of the Sloping Dividers is aligned with a pair of gripping arms sides (i.e. each gripping arm has two sides that may close against each other to grip) belonging to two separate neighboring gripping arms; The Sloping Dividers Module and the Gripping Arms Module (600) may then collectively travel horizontally separating the Branches/Twigs (top sections) of the Seedlings in each of the rows, while the Aligning Rods Module (400) prevents the premature or unintentional withdrawal of the Seedlings by retaining their Root Chunks (bottom sections).

At the end of this stage, the Aligning Rods Module (400) is stabilized in its position, the Sloping Dividers Module is stabilized in its position beyond and outside the Branches/Twigs (top sections) of the Seedling, and the Gripping Arms Module (600) is stabilized over the Seedlings in the Plants Tray, such that a pair of gripping arm sides is stabilized on the sides of, and facing form two sides of, each of the Branches/Twigs (top sections) of the Seedling.

(4) Horizontally mobilizing the Aligning Rods Module (400) over the one or more linear mobilizers from its position between Seedlings rows and out of the Plants Tray, and vertically raising the Sloping Dividers Module from its position adjacent to the Gripping Arms Module [N]. The Gripping Arms Module (600) is then vertically lowered onto the Plants Tray.

(5) The Gripping Arms Actuators Grid then triggers the closing of the arms of Gripping Arms Module (600) over the Stem/Stalk (middle section) of each of the Seedlings in the Plants Tray. The Gripping Arms Module (600) is then vertically raised while withdrawing the Seedlings from the Plants Tray leaving them hanging from the gripping arms. After the withdrawal of the Seedlings the remaining empty tray is mechanically (e.g. over linear mobilizers) or manually (e.g. a worker replacing the empty tray with a new one) removed and/or replaced with a new Plants Tray.

(6) The Gripping Arms Actuators Grid of the Gripping Arms Module (600) may be connected by two perpendicular sets, of parallel linear poles, passing over a pair of ball bearings within each of the actuators in the grid. An outer frame of the Gripping Arms Actuators Grid may trigger the extending and spreading out the Gripping Arms Grid over the linear poles (furthering the Gripping Arms away from each other), and/or the contracting and shrinking the Gripping Arms Grid over the linear poles (bringing the Gripping Arms closer to each other)—to accommodate between the Plants Tray and a destination Planting System Magazines, and/or for Plant Trays hosting different numbers of Seedlings. Once the Gripping Arms Grid has been extended/contracted, each of the withdrawn Seedlings is held by a gripping arm of the Gripping Arms Grid over and above a respective cell in the destination Planting System Magazine.

(7) Vertically lowering the Gripping Arms Grid into the cells of the destination Planting System Magazine, and utilizing the Gripping Arms Actuators Grid to open each of the gripping arms while releasing the gripped Seedlings into their respective cells in the Planting System Magazine.

(8) Vertically raising the Gripping Arms Grid out of the cells of the destination Planting System Magazine, while the released Seedlings remain in their respective cells in the Planting System Magazine. The now full Planting System Magazine may then be horizontally mobilized towards a planting block/module and/or a planting block/module conveyor, of the Planting System; while a new empty Planting System Magazine moves into its, now free, loading position.

(9) The Gripping Arms Actuators Grid may then trigger the extending and spreading out, and/or the contracting and shrinking, of the Gripping Arms Grid—to resize the grid for accommodating the next Plants Tray from which seedlings are to be withdrawn.

According to some embodiments, there may be provided a system for automated planting, said system comprising:
a. an array of grippers suspended from a grid of gripper supports, the grippers being comprised of opposing gripper arms suspended vertically from the gripper supports;
b. first mechanical actuators configured to cause a pinching action of the gripper arms by moving the bottom ends of the opposing gripper arms towards each other wherein said first mechanical actuators may be pneumatic;
c. second mechanical actuators configured to lift the grid of gripper supports, thereby lifting the array of grippers;
d. third mechanical actuators configured to modify spacing between the gripper supports, thereby modifying spacing between the pairs of grippers, while the grippers are in a pinching state, wherein modifying spacing between said gripper supports may be achieved by turning orthogonal horizontal rods supporting said gripper supports and having a helical ridge
e. an array of alignment rods comprised of horizontal rods and configured to be horizontally inserted between seedling stems of an array of seedlings contained in a seedling tray, wherein said alignment rods may have a concave cross section and/or a pointed end;
f. a physical accommodation for a seedling tray containing an array of seedlings, said physical accommodation including mechanical adaptations configured to position the seedling tray;
and
g. a dividing module comprising a set of vertical dividers positioned before the array of grippers, such that the vertical dividers pass between seedling stems of an array of seedlings contained in a seedling tray prior to the grippers moving into position to grip the seedlings, wherein said vertical dividers may have a sloped front.

According to some embodiments, there may be provided a method for automated planting, said method comprising:
a. receiving a seedling tray containing an array of seedlings;
b. positioning an array of grippers, comprised of pairs of opposing gripper arms suspended from a grid of gripper supports, above the seedling tray, such that each pair of opposing gripper arms is positioned to either side of a seedling,
c. mechanically causing a pinching action of said gripper arms;
d. mechanically lifting said grid of gripper supports, thereby lifting said array of grippers;
e. modifying spacing between said gripper supports, thereby modifying spacing between said pairs of grippers, while the grippers are in a pinching state, wherein said modifying spacing between gripper supports may be achieved by turning orthogonal horizontal rods supporting said gripper supports and having a helical ridge;
f. inserting an array of alignment rods, comprised of horizontal rods, between seedling stems of the array of seedlings, wherein said alignment rods may have a concave cross section and/or a pointed end;
g. passing a dividing module, comprising a set of vertical dividers, between the seedlings before the array of grippers, such that said vertical dividers pass between the seedling stems prior to said grippers moving into position to grip the seedlings, wherein said vertical dividers may have a sloped front.

According to some embodiments, there may be provided a system for automated planting, said system comprising:
a. a first subsystem configured to receive seedling trays, grip and lift seedlings from the seedling trays, respace the seedlings and release the seedlings into transitory seedling trays having a different spacing between seedlings from the received seedling trays;
b. a second subsystem configured to receive the transitory seedling trays, transfer the seedlings from the transitory seedling trays to a moving sequence of containers for individual seedlings; and
c. a third subsystem configured to create a hole in the ground for each seedling and individually transfer each seedling from the moving sequence of containers into the hole.
wherein the third subsystem may include tubes for transferring seedlings from the moving sequence of containers into the hole and pneumatic adaptations for using air pressure to improve movement of the seedlings through the tubes;
and
d. sensors for identifying empty containers within said sequence of containers.

According to further embodiments, the tubes may be twisted around a circular dispenser.

The present invention also employs in its implementation conventional tools, methodology and components. The details of such tools, component and methodology are not necessarily set forth herein for the sake of brevity. At the same time, numerous exemplary specific details are set forth, in order to provide a thorough understanding of the present invention. It should be recognized that the present invention might be practiced without resorting to the details specifically set forth in these examples.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for automated planting, said system comprising:
an array of grippers suspended from a grid of gripper supports,
said grippers being comprised of opposing gripper arms suspended vertically from said gripper supports;
first mechanical actuators configured to cause a pinching action of said gripper arms by moving the bottom ends of said opposing gripper arms towards each other;
second mechanical actuators configured to lift said grid of gripper supports, thereby lifting said array of grippers; and
third mechanical actuators configured to modify spacing between said gripper supports, thereby modifying spacing between said pairs of grippers, while the grippers are in a pinching state.

2. The system according to claim 1, further comprising an array of alignment rods comprised of horizontal rods and configured to be horizontally inserted between seedling stems of an array of seedlings contained in a seedling tray.

3. The system according to claim 2, wherein said alignment rods have a concave cross section.

4. The system according to claim 2, wherein said alignment rods have a pointed end.

5. The system according to claim 1, further comprising a physical accommodation for a seedling tray containing an array of seedlings, said physical accommodation including mechanical adaptations configured to position the seedling tray.

6. The system according to claim 1, further comprising a dividing module comprising a set of vertical dividers positioned before said array of grippers, such that said vertical dividers pass between seedling stems of an array of seedlings contained in a seedling tray prior to said grippers moving into position to grip the seedlings.

7. The system according to claim 6, wherein said vertical dividers have a sloped front.

8. The system according to claim 1, wherein said first mechanical actuators are pneumatic.

9. The system according to claim 1, wherein said third mechanical actuators modify spacing between said gripper supports by turning orthogonal horizontal rods supporting said gripper supports and having a helical ridge.

10. A method of automated planting, said method comprising:
receiving a seedling tray containing an array of seedlings;
positioning an array of grippers, comprised of pairs of opposing gripper arms suspended from a grid of gripper supports, above the seedling tray, such that each pair of opposing gripper arms is positioned to either side of a seedling,
mechanically causing a pinching action of said gripper arms;
mechanically lifting said grid of gripper supports, thereby lifting said array of grippers; and
modifying spacing between said gripper supports, thereby modifying spacing between said pairs of grippers, while the grippers are in a pinching state.

11. The method according to claim 10, further comprising inserting an array of alignment rods, comprised of horizontal rods, between seedling stems of the array of seedlings.

12. The method according to claim 11, wherein said alignment rods have a concave cross section.

13. The method according to claim 11, wherein said alignment rods have a pointed end.

14. The method according to claim 10, further comprising passing a dividing module, comprising a set of vertical dividers, between the seedlings before the array of grippers, such that said vertical dividers pass between the seedling stems prior to said grippers moving into position to grip the seedlings.

15. The method according to claim 14, wherein said vertical dividers have a sloped front.

16. The method according to claim 10, wherein said modify spacing between gripper supports is achieved by turning orthogonal horizontal rods supporting said gripper supports and having a helical ridge.

17. A system for automated planting, said system comprising;
a first subsystem configured to receive seedling trays, grip and lift seedlings from the seedling trays, respace the seedlings and release the seedlings into transitory seedling trays having a different spacing between seedlings from the received seedling trays;
a second subsystem configured to receive the transitory seedling trays, transfer the seedlings from the transitory seedling trays to a moving sequence of containers for individual seedlings; and
a third subsystem configured to create a hole in the ground for each seedling and individually transfer each seedling from the moving sequence of containers into the hole.

18. The system according to claim 17, wherein the third subsystem includes tubes for transferring seedlings from the moving sequence of containers into the hole and pneumatic adaptations for using air pressure to improve movement of the seedlings through the tubes.

19. The system according to claim 18, wherein said tubes are twisted around a circular dispenser.

20. The system according to claim 17, further comprising sensors for identifying empty containers within said sequence of containers.
